(19) United States
(12) Patent Application Publication
(10) Pub. No.: US 2016/0357712 A1
(43) Pub. Date: Dec. 8, 2016

(54) Document Summary Feed Generation Method, Apparatus and System

(71) Applicant: Apple Inc., Cupertino, CA (US)

(72) Inventors: Pepijn Zoon, San Francisco, CA (US); Jip van der Velde, Sunnyvale, CA (US); Steve E. Marmon, Mountain View, CA (US); Steven Evergreen, Cupertino, CA (US); Brian J. Turner, Belvedere-Tiburon, CA (US)

(21) Appl. No.: 14/872,031

(22) Filed: Sep. 30, 2015

Related U.S. Application Data
(60) Provisional application No. 62/172,215, filed on Jun. 7, 2015.

(51) Int. Cl. G06F 17/21; G06F 3/0485; G06F 17/24

(52) U.S. Cl. CPC G06F 17/212; G06F 17/24; G06F 3/0485

(57) ABSTRACT

Some embodiments of the invention provide a document reader that generates a display of several document summaries. In some embodiments, the reader receives definitions of several documents, and generates document summaries for these documents. The reader then identifies an arrangement of the document summaries on a scrollable page so that a first subset of the document summaries produces a snake pattern across the page while a second subset of the document summaries falls outside of the snake pattern. The snake pattern includes several successive vertical and horizontal snake portions. In some embodiments, the snake pattern traverses along a scrolling direction on the page (e.g., down the page in the direction of the page's scrolling). Also, in some embodiments, the widths of the vertical snake portions and the heights of the horizontal snake portions are within a certain threshold range.

### BACKGROUND

Content aggregators gather various electronic documents from various sources or publishers. The gathered documents can be articles that relate to a variety of different topics. Content aggregators typically provide summaries of the documents on a document summary page, which is often cluttered with lots of detail and irregular summary sizes. This clutter often detracts from the viewing experience and at times can make it harder to quickly absorb the content on the summary page.

### SUMMARY

Some embodiments of the invention provide a novel method for generating a page that contains summaries of a number of documents (e.g., article, webpages, etc.). In some embodiments, the page includes several sections (e.g., rows). The method receives a set of documents to summarize. The documents in the received set are sorted in an order (e.g., based on relevance to a viewer of the page). In some embodiments, the method uses a layout generator to identify an arrangement of one or more document summaries for each section on the page. The layout generator in some embodiments is a constrained solver (e.g., a constrained optimization solver).

For each of several sections of the page, the layout generator in some embodiments identifies several different arrangements for several document summaries. In some embodiments, the layout generator identifies several different arrangements for each section of the page, while in other embodiments, the layout generator can identify only one arrangement for at least one section. For each section for which the layout generator identifies multiple arrangements, the layout generator computes a score for each identified arrangement. In some embodiments, the layout generator identifies the arrangement of the document summaries on the page based on the generated scores.

In identifying different arrangements of document summaries, the layout generator in some embodiments explores, for the same group of documents, multiple arrangements that differ along one or more dimensions. In different embodiments, the layout generator explores the solution space along different sets of dimensions. Examples of these dimensions include: (1) different section layout templates (SLTs) for the same section, (2) different placements of one set of document summaries within the same SLT for a section, (3) different heights for an SLT, (4) different summaries with different amount of content for each document, etc. In some embodiments, an SLT has one or more document summary slots (DSS), each for placing and displaying a summary of one document. Also, in some embodiments, each DSS' vertical height can be adjusted to vary the amount of content placed in the summary. In some of these embodiments, changing the vertical height of a DSS can cause the height of the SLT that contains the DSS to also change.

In some embodiments, the layout generator computes a score for an identified arrangement of a section based on one or more of the above-described dimensions. For instance, in some embodiments, the score of an arrangement that is identified for a section page comprises (1) a score for the SLT that the section arrangement uses and (2) a score for the set of document summaries that would need to be placed in the SLT's set of slots (i.e., DSS). In some of these embodiments, the identified section arrangement's score also includes a score for placing this arrangement's SLT next to the SLT that is picked for a neighboring section. Other embodiments express the score for each identified section arrangement differently.

In some embodiments, the scoring of the section arrangements on a page is defined in order to produce an aesthetically pleasing layout of document summaries on the page. For instance, the generated score for a document summary that is fitted to a particular slot of a particular SLT accounts for the image size, image aspect ratio, overall aspect ratio, percentage of text-to-image, and amount of whitespace. The individual score for each of these factors is then combined by weight values that are defined to achieve a certain balance between the whitespace, image size, image aspect ratio, overall aspect ratio and text-to-image percentage in the document summary.

The layout generator of some embodiments also uses one or more constraints (i.e., rules) to produce an aesthetically appealing layout of document summaries on the page. Constraints are restrictions on the range of solutions that the layout generator explores. For instance, in some embodiments, the layout generator sequentially selects document summary arrangements for successive sections on the page. In some of these embodiments, after picking a first SLT with a first DSS arrangement for a first section, the layout generator will not explore for a second section that neighbors the first section, an SLT that has a DSS arrangement that does not look aesthetically pleasing when it is placed next to the first DSS arrangement.

Because the method receives the documents in a sorted order, the layout generator in some embodiments is also designed to explore the solution space of different document summaries and/or different section arrangements within a constrained boundary that is defined about the received sorted order. In this manner, the document summary layout that the layout generator produces for the page has a document summary order that is only slightly different than the order of the documents in the received sorted order. Therefore, the generated document summary layout mostly respects the original sorted order, while producing an aesthetically pleasing layout of the document summaries.

To explore the solution space within a constrained boundary that is defined about the received sorted order, the layout generator of some embodiments sequentially specifies document summary arrangements for successive sections on the page. For any particular section, the layout generator of some embodiments examines each SLT arrangement that is possible considering the SLT arrangement(s) that it selected for the previous section(s). Also, at the time that the layout generator is trying to select the document SLT arrangement for the particular section, the layout generator has picked SLT arrangements for the first N documents in the M received documents, where N and M are integers.

The SLT arrangements in the set of possible SLT arrangements for the particular section can have different numbers of slots. Some may have only one slot, while others can have up to P slots, where P is an integer. Accordingly, for the particular section and each possible SLT arrangement, the layout generator selects anywhere from 1 to P documents that are next in the sorted order in the remaining M-N documents. When the selected group of documents for a candidate SLT arrangement includes more than one document, the layout generator then explores each document for each slot of the SLT arrangement. Thus, within one group of documents that are selected for one SLT arrangement, the layout generator will explore placements that do not follow the sorted order of documents. However, the order of the document summaries across section boundaries does not violate the order of the corresponding documents in the received set of documents. Thus, a summary for a first document is never placed in a second section that is after a first section that contains a summary for a second document that is later in the sorted order than the first document.

The above-described implementation of the layout generator is simply provided to explain how the layout generator of some embodiments explores the solution space of different document summaries and/or different section arrangements within a constrained boundary that is defined about the received sorted order. One of ordinary skill will realize that many other implementations of the layout generator exist and these other implementations explore the solution space in a different manner while also ensuring that their aesthetically pleasing page layout arrangements respect the received sorted order.

For instance, in other embodiments, the layout generator uses a multi-pass approach to defining the layout of document summaries across a set of rows of a page. In some of these embodiments, the page layout is one column of vertically aligned rows, and the page sections are the rows. In the multi-pass approach, the layout generator defines a directed acyclic graph (DAG) in which multiple nodes are defined at multiple levels of the graph structure and each node can have multiple parent nodes and multiple child nodes, but no node can be a parent of a higher level node. For each row, the layout generator, in a first pass, defines all candidate SLT arrangements for that row and defines a node in the DAG for each defined SLT arrangement. In this approach, the candidate SLT arrangements of one row are all on the same level in the DAG.

In the first pass, the layout generator identifies each possible transition between the SLT arrangements of one row and the SLT arrangements of the next subsequent row. As mentioned above, some transitions are not possible, as not every SLT can follow every other SLT in some embodiments. For each identified transition between two SLTs of two adjacent rows, the layout generator in the first pass specifies an edge between the two nodes that represent the two SLTs in the DAG, and assigns a score to the edge to express the desirability of the transition from the first SLT to the second SLT.

After defining the candidate SLTs for the set of rows, defining their nodes and scoring their transitions, the layout generator has completed the first pass. In the second pass, the layout generator identifies all complete paths from the top to the bottom of the DAG, and computes the score of each path by summing the scores of the DAG edges (i.e., the transitions between the nodes) taken by the path. Each path represents one complete SLT layout solution for the document summaries that are to be placed in the set of rows. Each path's score represents the desirability of the transitions between the SLT arrangements of the path (i.e., the SLT arrangements that are represented by the nodes on the path).

In the second pass, the layout generator then identifies a set of paths that have the highest score. The layout generator iteratively examines each path in the identified set to explore different document summary placements, contents and sizes in the SLT arrangements of each path. For each explored document summary SLT solution, the layout generator computes a score according to one or more of the content and size scoring techniques that were described above. The layout generator then selects the SLT layout arrangement of the path that produced the best cumulative score across all of its SLT arrangements. The selected SLT layout arrangement specifies the SLTs for the set of rows, and the document summaries in these SLTS.

To limit the exploration of the layout generator, some embodiments restrict the layout generator's exploration of different document summaries for different rows to a constrained boundary about the received order of the documents, as described above. To further limit this exploration, some embodiments also use a static or dynamic timer (e.g., fixed timer or a timer based on user actions) to restrict the time that the layout generator has to explore the high-scoring paths in the identified set in the second pass.

Also, in the second pass, the layout generator may determine that a node on a high scoring path is an SLT arrangement that is not feasible for the documents that need to be summarized in the SLT. In such a case, the layout generator filters out that node and all paths that use that node. This filtering might eliminate some or all of the high-scoring paths. When all of the high-scoring paths are filtered out, the layout generator would have to select another set of high-scoring paths by identifying the next highest path score and identifying the paths that have this next highest path score.

As mentioned above, the page layout is one column of vertically aligned rows in some embodiments. In some of these embodiments, the layout generator is biased towards producing a page layout that has an alternating sequence of vertically aligned slots and horizontally aligned slots in various neighboring rows. These aligned patterns of slots are referred to as snake patterns that are laid out across all or contiguous portions of the layout. Adjacent to the snake patterns are larger sized document summaries, which in combination with the snake patterns provide a visually pleasing layout of document summaries.

To facilitate the creation of such a snake layout, the layout generator in some embodiments uses a collection of section arrangements that can be categorized as (1) a vertical snake arrangement, (2) a horizontal snake arrangement, and (3) a snake breaking arrangement. In some embodiments, each vertical snake arrangement has a narrow vertical section that provides the appearance of a vertical portion of the snake, and a wider section that provides a larger counterbalance to the narrow vertical section in order to further solidify the appearance of the snake portion that is created by the vertical snake arrangement and adjacent horizontal snake arrangements. A vertical snake arrangement can be further characterized as a right snake arrangement or a left snake arrangement depending on whether its narrow section is on the right or left side of the snake.

For sets of contiguous rows, the layout generator in some embodiments is biased towards selecting alternating sequences of vertical and horizontal snake arrangements. In such an alternating sequence, each vertical sequence is followed by a horizontal snake arrangement and vice versa. Also, in some embodiments, the narrower portions (called the vertical snake portions below) of two vertical snake arrangements that are on different sides of the horizontal snake arrangement have to be on opposing sides of the page column (i.e., the single column created by the page's vertically stacked rows).

In some embodiments, the horizontal snake portion has at least three sections, two of which appear on opposing sides of the page column to align with the vertical snake portions that align to the top or bottom of them. Other embodiments have other types of horizontal snake portions. For instance, in addition to having horizontal snake portions with at least three sections as described above, some embodiments also have horizontal snake portions with fewer sections (e.g., one or two sections) but impose height restrictions on the horizontal snake portions to ensure that these horizontal snake portions do not distort the appearance of the snake.

For instance, some embodiments impose one or more rules (e.g., constraints) on the height of the horizontal snake portion so that this height is equal to or is within a threshold of the width of the vertical snake portions, so that the “snake” does not appear to get wider and then narrower as the snake traverses in the horizontal and then vertical directions. Some embodiments also have one or more rules (1) on a minimum number of alternating vertical and horizontal snake arrangements that have to be placed in sequence once a snake pattern starts, and (2) on a maximum number of alternating vertical and horizontal snake arrangements in one contiguous snake portion formed by such arrangements.

A snake portion that is formed by vertical and horizontal snake arrangements can be broken by a snake breaking arrangement, which is also referred to below as a non-snake component. Some snake breaking arrangements are snake crossers in that they are symmetric arrangements and because of this symmetry, the snake can resume on either end of the page column after the snake crossers. Other snake arrangements are not snake crossers. They are asymmetric arrangements that have different sized sections on opposing ends of the page column. Because of their asymmetric design, the vertical snake portions on either side of an asymmetric snake breaker have to be on opposing sides of the page column. Some embodiments enforce this approach by having a design rule that requires the narrow sides of successive asymmetric components (snake components or non-snake components) to alternate (i.e., to flip from side of the page column to the other side of the page column). In some embodiments, this rule is enforced even when two asymmetric components have one intervening symmetric component between them. Some embodiments, however, do not enforce this rule when the intervening symmetric component is a snake crosser (i.e., a component that allows the vertical snake component to enter and leave the crosser on the same side). An example of such a snake crosser in some embodiments is a single-slot SLT (i.e., an SLT with a single column-wide slot) of a certain minimum height.

Some embodiments also have a design rule that prevents two SLTs from being placed in two successive rows when the two SLTs have two overlapping slots that have their vertical boundaries misaligned by a small amount. For instance, the width of a narrow section of an asymmetric snake breaker may only be slightly larger than the width of the vertical snake portion of the adjacent vertical snake component. Placing such a similarly sized section next to the vertical snake portion would lead to page layout that would not look good. Accordingly, in some embodiments, the layout generator has a rule that prevents it from placing such a narrower section of an asymmetric snake portion next to a vertical snake portion of a vertical snake arrangement. Also, in some embodiments, an asymmetric snake breaker cannot follow a horizontal snake arrangement. In other embodiments, no snake crosser can follow a horizontal snake arrangement.

One of ordinary skill will realize that the preceding Summary is intended to serve as a brief introduction to some inventive features of some embodiments. Moreover, this Summary is not meant to be an introduction or overview of all-inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF DRAWINGS

The novel features of the invention are set forth in the appended claims. However, for purposes of explanation, several embodiments of the invention are set forth in the following figures.

FIG. 1 illustrates one example of a page that is populated by the layout generator of some embodiments.

FIG. 2 illustrates an example of some such rules that are used by the layout generator of some embodiments.

FIG. 3 illustrates four layout examples that show how components can serve as snake crossers in some embodiments.

FIG. 4 illustrates an example of a snake pattern on a page that is generated by a reader application of some embodiments.

FIG. 5 illustrates a layout generation process that the layout generator of some embodiments uses to generate a summary feed page for several articles that it receives in a sorted order.

FIG. 6 illustrates a layout generator that specifies a SLT arrangement for a page.

FIGS. 7 and 8 illustrate two different layout solutions and for the second row of the page.

FIG. 9 illustrates another layout solution for the second row of the page.

FIG. 10 illustrates yet another layout solution for the second row of the page.

FIGS. 11 and 12 illustrate examples of a process for exploring third-row solutions that are off the second-row solution of FIG. 9.

FIGS. 13 and 14 illustrate examples of a process for exploring third-row solutions that are off the second-row solution of FIG. 10.

FIG. 15 illustrates a process to explore, for one row, one or more SLTs and one or more CSPs for each explored SLT.

FIG. 16 illustrates a process that generates all possible CSPs for an article and an SLT.

FIG. 17 illustrates an example of a constraint on CSPs for different article summaries.

FIG. 18 illustrates a process that the layout generators of some embodiments use to explore the solution space.

FIG. 19 illustrates an example of one DAG structure that is created by the first pass.

FIG. 20 illustrates an example of an architecture of a mobile computing device of some embodiments.

FIG. 21 conceptually illustrates an example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a novel method for generating a page that contains summaries of a number of documents. In some embodiments, the page includes several sections. The method receives a set of documents to summarize. In the received set, the documents are sorted in an order (e.g., based on relevance to a user). In some embodiments, the method uses a layout generator to identify an arrangement of one or more document summaries for each section on the page. The layout generator in some embodiments is a constrained solver (e.g., a constrained optimization solver).

For each of several sections of the page, the layout generator in some embodiments identifies several different arrangements for several document summaries. In some embodiments, the layout generator identifies several different arrangements for each section of the page, while in other embodiments, the layout generator may identify only one arrangement for at least one section. For each section for which the layout generator identifies multiple arrangements, the layout generator computes a score for each identified arrangement. In some embodiments, the layout generator identifies the arrangement of the document summaries on the page based on the generated scores.

In identifying different arrangements of document summaries, the layout generator in some embodiments explores for the same group of documents, multiple arrangements that differ along one or more dimensions. In different embodiments, the layout generator explores the solution space along different sets of dimensions. Examples of these dimensions include: (1) different section layout templates (SLTs) for the same section, (2) different placements of one set of document summaries within the same SLT for a section, (3) different heights for an SLT, (4) different summaries with different amount of content for each document, etc. In some embodiments, an SLT has one or more document summary slots (DSS), each for placing and displaying a summary of one document. Also, in some embodiments, each DSS' vertical height can be adjusted to vary the amount of content placed in the summary. In some of these embodiments, changing the vertical height of a DSS can cause the height of the SLT that contains the DSS to also change.

In some embodiments, the layout generator computes a score for an identified arrangement of a section based on one or more of the above-described dimensions. For instance, in some embodiments, the score of an arrangement that is identified for a section of the page comprises (1) a score for the SLT that the section arrangement uses and (2) a score for the set of document summaries that would need to be placed in the SLT's set of slots. In some of these embodiments, the identified section arrangement's score also includes a score for placing this arrangement's SLT next to the SLT that is picked for a neighboring section. Other embodiments express the score for each identified section arrangement differently.

In some embodiments, the scoring of the section arrangements on a page is defined in order to produce an aesthetically pleasing layout of document summaries on the page. For instance, the generated score for a document summary that is fitted to a particular slot of a particular SLT accounts for the image size, image aspect ratio, overall aspect ratio, percentage of text-to-image and amount of whitespace. The individual score for each of these factors is then combined by weight values that are defined to achieve a certain balance between the whitespace, image size, image aspect ratio, overall aspect ratio and text-to-image percentage in the document summary.

The layout generator of some embodiments also uses one or more constraints that are defined to produce an aesthetically appealing layout of document summaries on the page. Constraints are restrictions on the range of solutions that the layout generator explores. For instance, in some embodiments, the layout generator sequentially selects document summary arrangements for successive sections on the page. In some of these embodiments, after picking a first SLT with a first DSS arrangement for a first section, the layout generator will not explore for a second section that neighbors the first section, an SLT that has a DSS arrangement that does not look aesthetically pleasing when it is placed next to the first DSS arrangement.

Because the method receives the documents in a sorted order, the layout generator in some embodiments is designed to explore the solution space of different document summaries and/or different section arrangements within a constrained boundary that is defined about the received sorted order. In this manner, the document summary layout that the layout generator produces for the page has a document summary order that is only slightly different than the order of the documents in the received sorted order. Therefore, the generated document summary layout mostly respects the original sorted order, while producing an aesthetically pleasing layout of the document summaries.

To explore the solution space within a constrained boundary that is defined about the received sorted order, the layout generator of some embodiments sequentially specifies document summary arrangements for successive sections on the page. For any particular section, the layout generator of some embodiments examines each SLT arrangement that is possible considering the SLT arrangement(s) that it selected for the previous section(s). Also, at the time that the layout generator is trying to select the document SLT arrangement for the particular section, the layout generator has picked SLT arrangements for the first N documents in the M received documents, where N and M are integers.

The SLT arrangements in the set of possible SLT arrangements for the particular section can have different numbers of slots. Some may have only 1 slot, while others can have up to P slots, where P is an integer greater than 1. Accordingly, for the particular section and each possible SLT arrangement, the layout generator selects anywhere from 1 to P documents that are next in the sorted order in the remaining M-N documents. When the selected group of documents for a candidate SLT arrangement includes more than one document, the layout generator then explores each document in each slot of the SLT arrangement. Thus, within one group of documents that are selected for one SLT arrangement, the layout generator will explore placements that do not follow the sorted order of documents. However, the order of the document summaries across section boundaries does not violate the order of the corresponding documents in the received set of documents. Thus, a summary for a first document is never placed in a second section that is after a first section that contains a summary for a second document that is later in the sorted order than the first document.

The above-described implementation of the layout generator is simply provided to explain how the layout generator of some embodiments explores the solution space of different document summaries and/or different section arrangements within a constrained boundary that is defined about the received sorted order. One of ordinary skill will realize that many other implementations of the layout generator exist and these other implementations explore the solution space in a different manner while also ensuring that their aesthetically pleasing page layout arrangements respect the received sorted order. Other implementations of the layout generator will be described below.

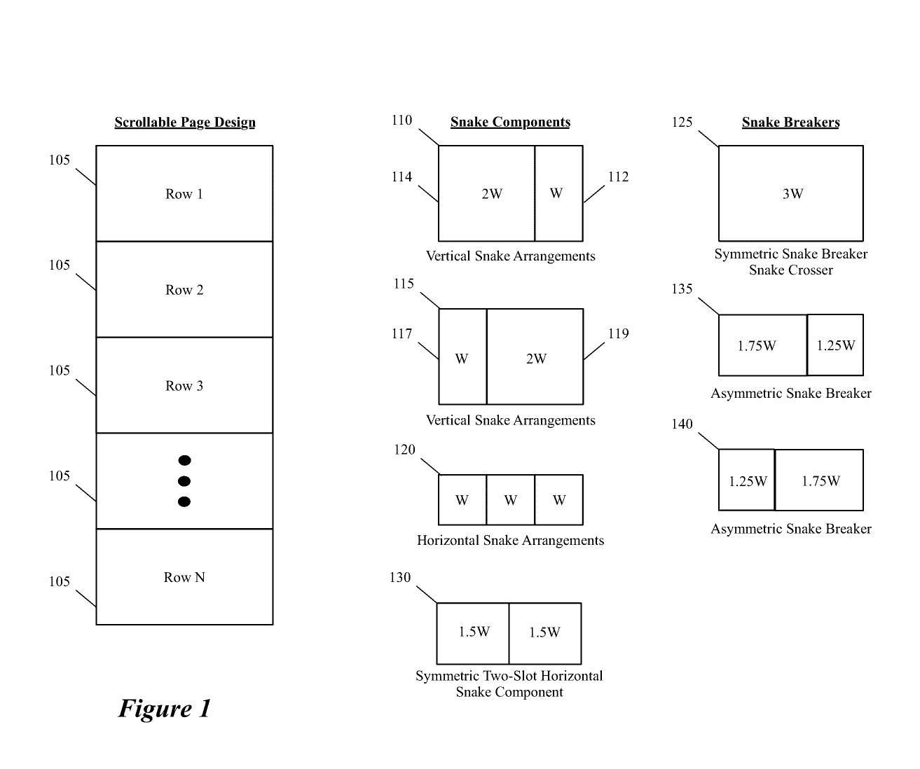

FIG. 1 illustrates one example of a page 100 that is populated by the layout generator of some embodiments. As shown, the page 100 in this example is a scrollable page that includes one column of vertically aligned rows 105. These rows are the sections of the page in which the layout generator places document summaries.

In some of these embodiments, the layout generator is biased towards producing a page layout that has an alternating sequence of vertically aligned slots and horizontally aligned slots in various neighboring rows for displaying document summaries. These aligned patterns of slots are referred to as snake patterns that are laid out across all or contiguous portions of the layout. Adjacent to the snake patterns are larger sized document summaries, which in combination with the snake patterns provide a visually pleasing layout of document summaries.

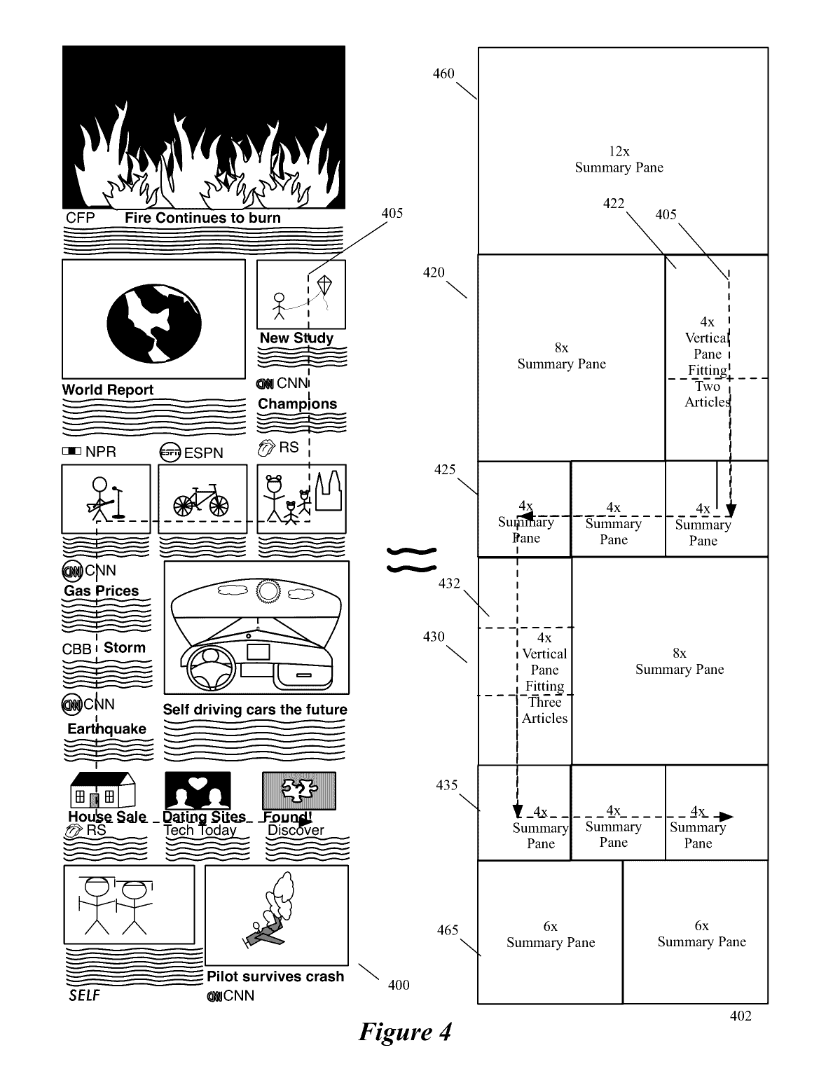

FIG. 1 also shows a number of SLTs that the layout generator explores as candidate templates for arranging document summaries in the rows. As shown, the SLTs are grouped into two sets, a snake component group and a snake breaker component group. The group names refer to how the layout generator uses them. The layout generator (1) uses the snake components to define a pattern of document summaries that appears as a snake that is moving from one side of the page column to the other side of the page column, and (2) uses the snake breakers to break the snake pattern. One example of such a snake pattern will be further described below by reference to FIG. 4.

As shown in FIG. 1, the snake components include two vertical snake arrangement 110 and 115 and two horizontal snake arrangements 120 and 130, while the snake breakers include a single column-wide slot snake breaker 125 and two asymmetric two-slot breakers 135 and 140. The vertical snake arrangement 110 is called a right snake arrangement, while vertical snake arrangement 115 is called a left snake arrangement. As shown, each vertical snake arrangement has a narrow vertical section 112 or 117 that provides the appearance of a vertical portion of the snake, and a wider section 114 or 119 that provides a larger counterbalance to the narrow vertical section in order to further solidify the appearance of the snake portion that is created by the vertical snake arrangement and adjacent horizontal snake arrangements. In this example, the narrower vertical section 112 or 117 has a width W, which is half the width 2 W of the wider section 114 or 119.

In the example illustrated in FIG. 1, the horizontal snake arrangement 120 has three slots, each with the same width W as the narrow vertical portions 112 and 117 of the vertical snake arrangements 110 and 115, in order to align with these vertical snake portions when these portions are stacked above or below the horizontal snake arrangement. In other embodiments, such a horizontal snake arrangement can be divided into more sections and/or have different sized sections. For instance, in some embodiments, the horizontal snake component has two sections on its opposing ends and these two slots have the same width as the width of the vertical snake portions on which they stack. Between these two sections, this horizontal snake component has one section with a different width in some embodiments. In other embodiments, the horizontal snake component has more than one slot with the same or with a different width than the width of the slots at the opposing end of the component.

The horizontal snake component 130 is a symmetric two-slot horizontal snake component with two equal sized slots for placing document summaries, and each slot is 1.5 times (1.5 W) wider than the vertical snake portion. In some embodiments, this component is a snake component because its height cannot exceed a certain threshold (e.g., 5 or 10 percent) of the width of the vertical snake portion, in order to ensure that this component does not distort the appearance of the snake. Some embodiments also impose this height constraint on the horizontal snake component 120. In other embodiments, the horizontal component 130 is not a snake component but is a snake breaker (e.g., its height can grow to a certain size such that it would disrupt the snake pattern). In yet other embodiments, the horizontal component 130 can serve either as a snake component or a snake breaker (e.g., depending on whether it abides by the height constraint).

For sets of contiguous rows, the layout generator is biased towards selecting an alternating sequence of vertical and horizontal snake arrangements. In such an alternating sequence, each vertical sequence is followed by a horizontal snake arrangement and vice versa. To bias the layout generator to produce visually pleasing snake layouts, some embodiments define a set of rules (e.g., constraints) on how the layout generator positions SLT arrangements next to each other.

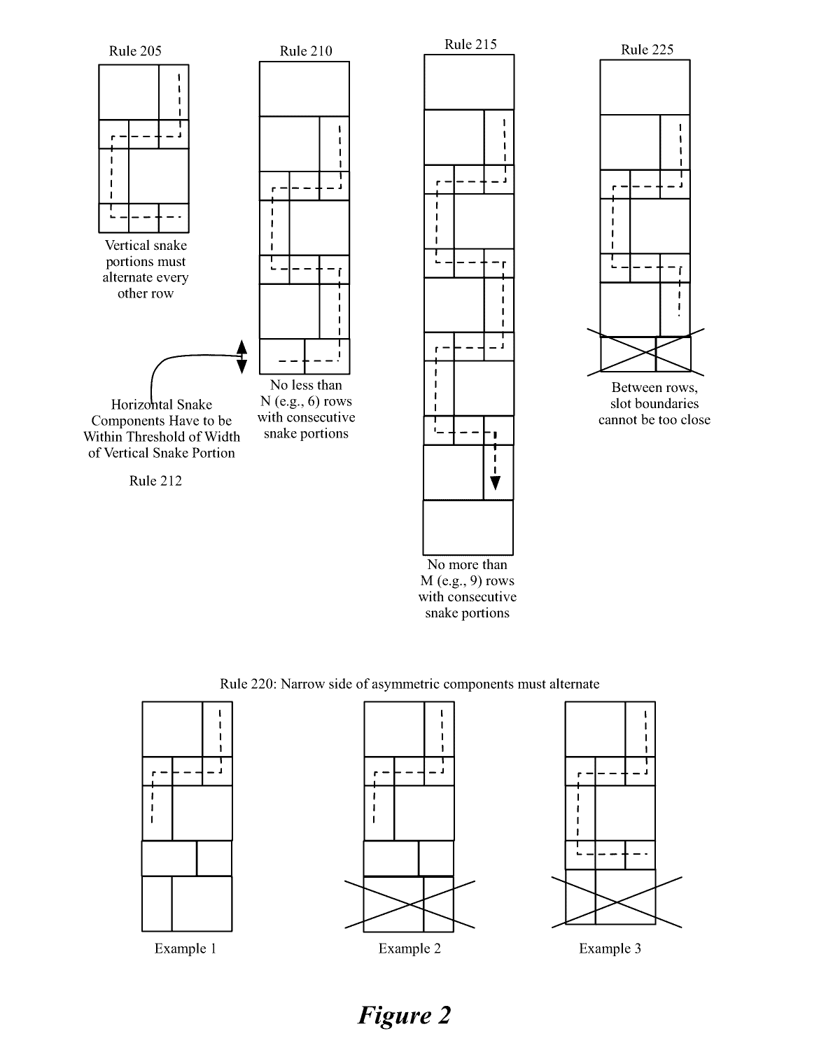

FIG. 2 illustrates an example of some such rules that are used by the layout generator of some embodiments. Different combinations of these rules are used in different embodiments. Also, some embodiments have additional design rules to supplement the rules illustrated in FIG. 2. In some embodiments, all rules illustrated in FIG. 2 are absolute rules that the layout generator cannot break, while in other embodiments, some or all of these rules can be broken, but the layout generator has to heavily penalize any layout that runs afoul of the rules.

As shown, one rule 205 directs the layout generator to arrange the snake components such that the vertical snake portions (i.e., the portions 112 and 117 of the vertical snake components 110 and 115) of two vertical snake arrangements that are on different sides of a horizontal snake arrangement are on opposing sides of the page column (i.e., the single column created by the page's vertically stacked rows).

Once a layout generator starts a snake pattern by placing an alternating sequence of vertical and horizontal snake arrangements in a contiguous set of rows, another rule 210 directs the layout generator not to break the snake pattern until a minimum number of alternating vertical and horizontal snake arrangements have been placed in sequence. Also, in some embodiments, another rule 215 directs the layout generator to insert a snake breaking component in order to introduce a break in the snake pattern, after a maximum number of alternating vertical and horizontal snake arrangements. In the examples illustrated in FIG. 2, the minimum and maximum number of contiguous rows with snake components are 6 and 9. These numbers can be different in other embodiments.

As indicated by rule 212, some embodiments also impose one or more rules (e.g., constraints) on the height of the horizontal snake portion so that this height is equal to or is within a threshold of the width of the vertical snake portions. Such a rule prevents the “snake” from appearing to get wider in the horizontal directions and narrower in the vertical directions. In this example, rule 212 shows its applicability to a symmetric two-slot horizontal snake component.

Rule 220 is applicable to asymmetric snake and non-snake components. The asymmetric two-slot breakers 135 and 140 each has two different sized document summary slots. These two breakers have the same two slots, but their orders are flipped. One slot is 1.25 times (1.25 W) wider than the vertical snake portion, while the other slot is 1.75 times (1.75 W). Hence, each asymmetric arrangement 135 or 140 has different sized slots on opposing ends of the page column.

Rule 220 requires the narrow sides of successive asymmetric components (snake components or non-snake components) to alternate (i.e., to flip from one side of the page column to the other side of the page column), as shown by the first and second examples for this rule in FIG. 2. In some embodiments, this rule is enforced even when two asymmetric components have one intervening symmetric component between them, as shown by the third example for this rule on FIG. 2.

Some embodiments, however, do not enforce this rule when the intervening symmetric component is a snake crosser, which is a component that allows the vertical snake component to enter and leave the crosser on the same side. An example of such a snake crosser in some embodiments is the single-slot snake breaker 125. As shown, this breaker 125 has one slot for inserting a document summary, and this slot has a width that is three times (3 W) the width of the vertical snake portions 112 or 117 in this example.

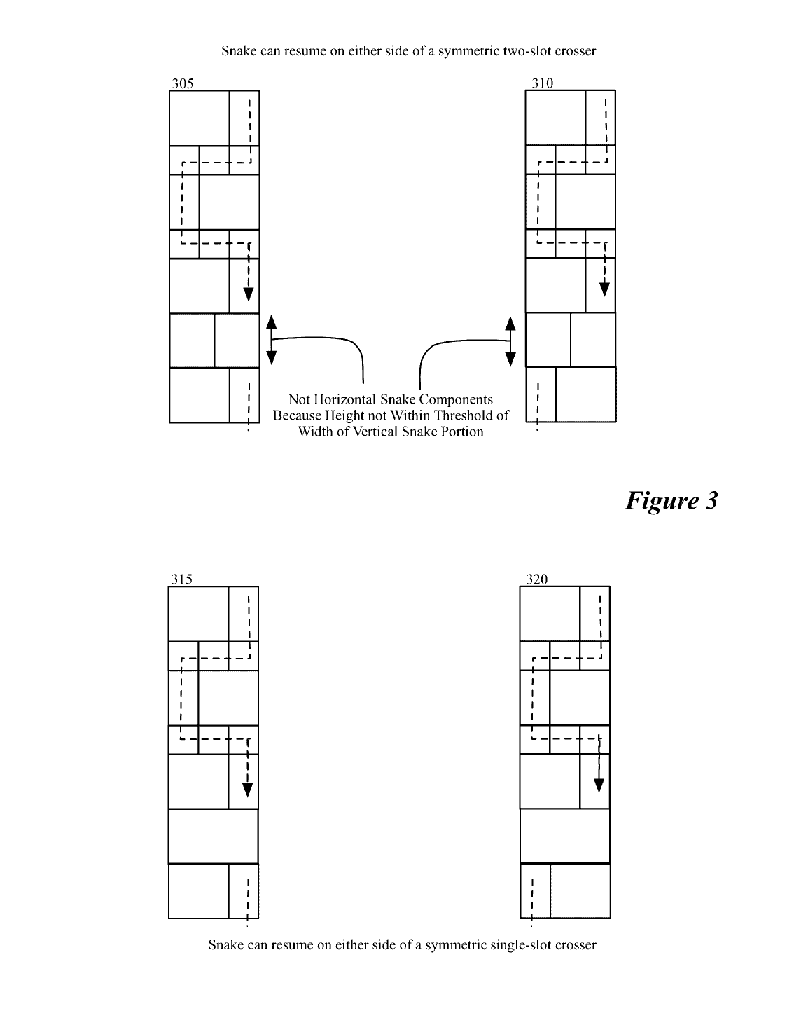

In some embodiments, the symmetric two-slot component 130 can also serve as a snake crosser when it is not serving as a horizontal snake component (e.g., when its height is larger than a maximum allowable height of a horizontal snake component). FIG. 3 illustrates four layout examples 305-320 that show how components 125 and 130 can serve as snake crossers in some embodiments. These components have symmetric arrangements that allow the snake to resume on either end of the page column after them (e.g., to exit the crosser on the same side as entering the crosser). In this example, the symmetric two-slot component 130 can serve as a snake crosser because it does not serve as a horizontal snake component as its height is larger than the maximum allowable horizontal snake component size.

Some embodiments also have a design rule that prevents two SLTs from being placed in two successive rows, when the two SLTs have two overlapping slots that have their vertical boundaries misaligned by a small amount. For example, the rule 225 of FIG. 2 prohibits a second arrangement from following a first arrangement when the second arrangement has a second slot that is within a threshold size of a first slot of the first arrangement and the second slot would need to be placed next to the first slot. In this example, the second arrangement is an asymmetric snake breaker that is placed next to a vertical snake arrangement. In some embodiments, the narrower section of the asymmetric snake breaker is only slightly wider than the vertical snake portion. Placing such a narrower section next to a vertical snake portion would not lead to an aesthetically pleasing page layout. Accordingly, in some embodiments, the layout generator has a rule that prevents it from placing two arrangements next to each other when the boundary of vertically overlapping slots is slightly misaligned.

For the examples illustrated in FIG. 2, some of the rules necessarily subsume the other rules (e.g., rule 225 necessarily subsumes rule 205). Also, in some embodiments, an asymmetric snake breaker cannot follow a horizontal snake arrangement. Again, in the example illustrated in FIG. 2, this prohibition is enforced by rule 225. In some embodiments, no snake breaker can follow a horizontal snake arrangement.

Also, other embodiments define other rules (e.g., other constraints) based on the type of content inserted in each DSS. For instance, in some embodiments, the layout generator can place two horizontal snake arrangements next to each other when producing a feed layout page for a number of articles. However, in these embodiments, the layout generator cannot include an image from any of the articles in any slot in either horizontal arrangement.

With the exception of the vertical snake arrangements 110 and 115, the layout generator can only place one document summary in the document summary slot(s) of the other snake and non-snake components in some embodiments. In the vertical snake portion 112 and 117 of the vertical snake arrangements 110 and 115, the layout generator of some embodiments can insert anywhere from 1 to 3 document summaries. In other words, the layout generator in some embodiments can break a vertical snake portion 112 or 117 into one slot, two slots, or three slots. The layout generator uses other layout rules in some embodiments.

FIG. 4 illustrates an example of a snake pattern 405 on a page 400 that is generated by a reader application of some embodiments. The reader application gathers articles that may be of interest to a user, generates the feed page 400 that summarizes the most relevant articles, and presents the articles once they are selected from the feed page. The interaction between the user and the reader application is further described in concurrently filed U.S. patent application entitled “Graphical User Interface for a Document Reader application”, with the Attorney Docket No. “APLE.P0671”.

For the page 400, FIG. 4 presents a skeleton 402 that illustrates the row layout templates that are used to make the page layout 400. As shown, the page 400 has six rows of content, which include summaries of sixteen articles. The page layout is twelve units wide. In some embodiments, these units are referred to as columns, or as sub-columns of the page column. As shown, the first and sixth rows 460 and 465 include snake-breaking arrangements, while the second-fifth rows include snake component arrangements 420-435. The snake SLTs in the second and fourth rows are opposing vertical snake arrangements 420 and 430, while the snake SLTs in the third and fifth rows are horizontal snake arrangements 425 and 435. In this example, the vertical snake portions of the vertical snake arrangement are 4 units wide in this example.

The first row includes a 12-unit wide single snake breaker 460, while the sixth row includes a dual-slot symmetric snake breaker 465. In this example, each slot of the snake breaker 465 is 6-units wide, and the height of this snake breaker is larger than the maximum allowable height for a horizontal snake component. In other embodiments, the dual-slot symmetric snake breakers can only serve as horizontal snake components and not snake breakers.

As shown, the snake pattern 405 is formed by the vertical portion 422 of the right-hand snake component 420, the horizontal snake component 425, the vertical portion 432 of the left-handed snake component 430, and the horizontal snake component 435. As further shown, the vertical portion 422 contains two article summaries, while the vertical portion 432 contains three articles summaries. In some embodiments, the vertical snake portions can contain a variable number of article summaries (e.g., 1 to 3 summaries).

In some embodiments, different document summary slots in a layout may include different types of content. For instance, in the example illustrated in FIG. 4, the summaries in the vertical portion 422 include images, titles and excerpts, while the summaries in the vertical portion 432 only include titles and excerpts (i.e., do not contain images). The excerpts of some embodiments are portions (or brief summaries) of the full written content of the articles. In some embodiments, the reader's layout generator can include titles, images, and excerpts in the article summaries on a feed page layout. In some of these embodiments, the generator explores different sizes for the document summary slots and for each of the different sizes, determines the amount and type of content that it can include. This process will be further described below.

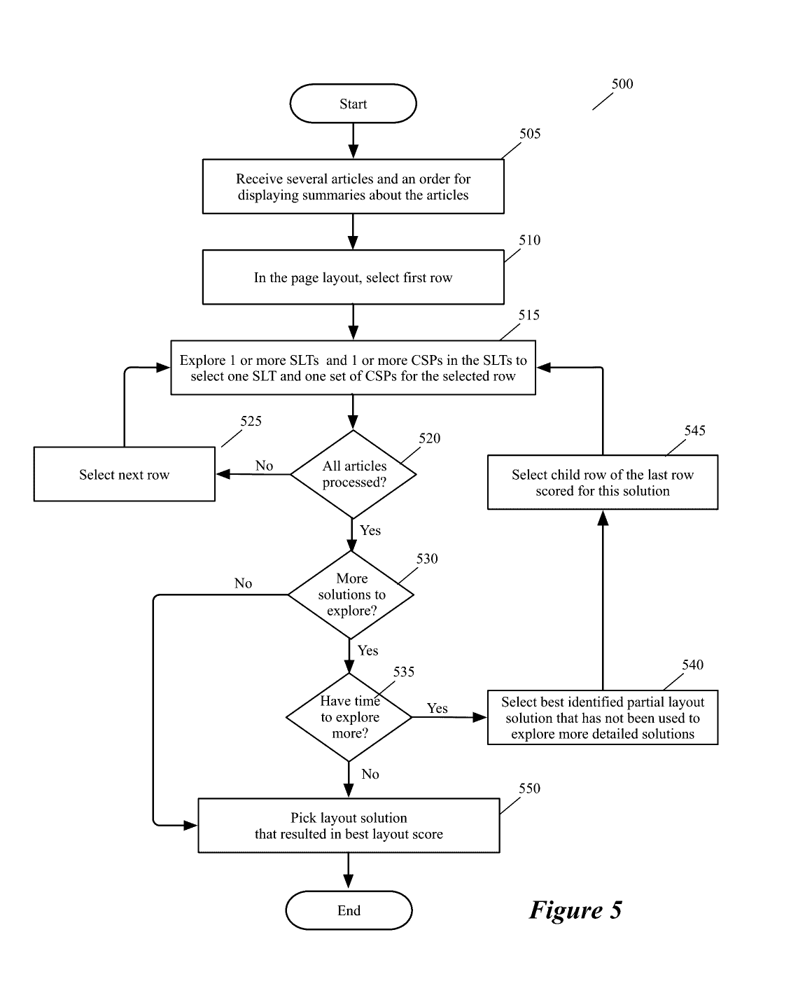

In FIG. 4 and in the discussion below, the document summaries that the layout generator explores and places in the document summary slots are referred as content summary panes (CSP). Also, in the examples provided in FIG. 4 and in FIGS. 5-17 described below, the documents are articles for which some embodiments generate a summary feed page that provides a summary of the articles. One of ordinary skill will realize that the processes and solutions that are described by reference to FIGS. 4-17, are equally applicable to generating a summary page that summarizes any group of documents.

FIG. 5 illustrates a layout generation process 500 that the layout generator of some embodiments uses to generate a summary feed page (such as page 400) for several articles that it receives in a sorted order. To generate the page, the process 500 explores the solution space of different article summaries and/or different row arrangements within a constrained boundary that is defined about the received sorted order of the articles.

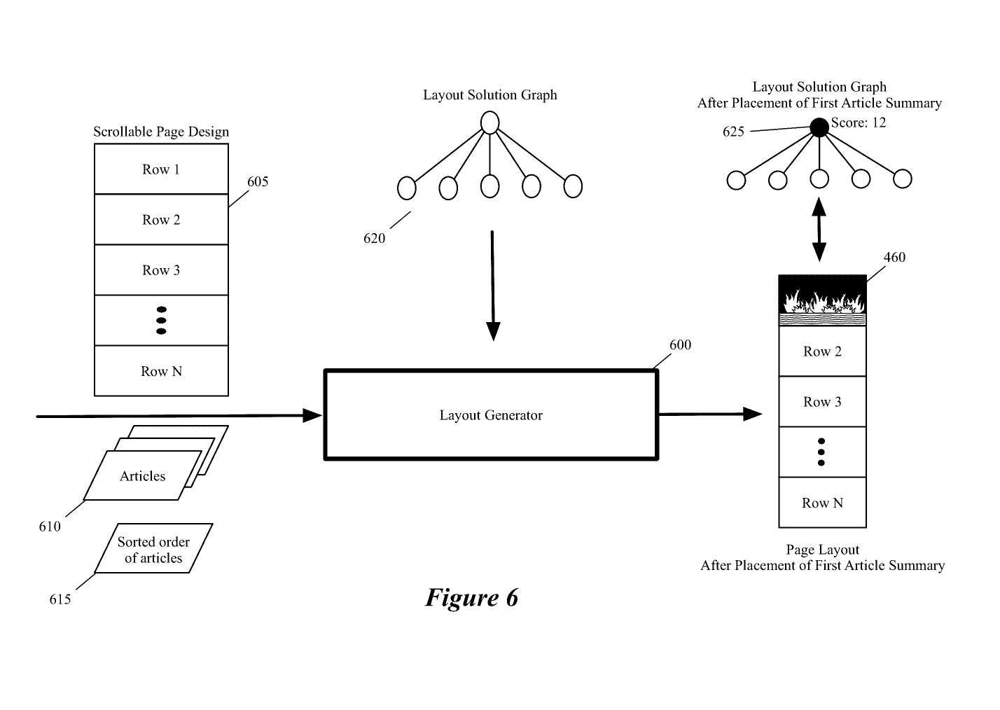

In exploring the solution space within a constrained boundary about the received sorted order, the process 500 sequentially specifies article summary arrangements for successive rows on the page. The process 500 will be described by examples illustrated in FIGS. 6-14, which show various operations that the process 500 performs to explore the solution space for one row and for successive rows.

As shown, the process 500 initially receives (at 505) several articles and an order that specifies a particular sequence for displaying the summaries of the articles in the feed layout page. In some embodiments, the specified order is based on the predicted relevance of the article to a viewer of the feed layout page. Any number of common techniques for specifying the relevance of a series of documents can be employed (at 505) to derive the specified order of the articles.

The process 500 then selects (at 510) the first row in the page layout. Next, at 515, the process explores one or more SLTs and one or more CSPs for each explored SLT, in order to select one SLT and one set of CSPs that are placed in the SLT's set of slots to summarize one set of articles. In some embodiments, exploring different CSPs for an SLT entails placing different article summaries in different slots of an SLT, varying the sizes of the SLT slots, and/or including different amounts of content for each article in each SLT slot.

Next, at 520, the process determines whether it has identified a location for the summary of each article that it received at 505. If not, the process selects (at 525) the next row, and then returns to 515 to explore the solution space for this row and specify an SLT and a set of CSPs for this newly selected row. In iteratively exploring (at 515) the solution space for successive rows, the process 500 uses one or more constraints to limit the range of solutions that the layout generator explores, while producing an aesthetically appealing layout of article summaries on the page.

For example, in each iteration through 515 for a row, the process of some embodiments only examines each SLT arrangement that is possible considering the SLT arrangement(s) that it selected for the previous row(s). Thus, after picking a first SLT with a first slot arrangement for a first row, the process 500 in some embodiments will not explore for a second row that follows the first row, an SLT that has a slot arrangement that does not look aesthetically pleasing when it is placed next to the first slot arrangement.

Also, the process 500 in some embodiments only explores article summary layouts in which the order of the article summaries is only slightly different than the order of the articles in the received sorted order. For example, in each iteration through 515 for a row, the process of some embodiments only examines placement of the batch of articles that are next in the sorted order. Specifically, at the time that the process 500 is trying to select the article SLT arrangement for a particular row, the process has picked SLT arrangements for the first N articles in the M received articles, where N and M are integers.

The SLT arrangements in the set of possible SLT arrangements for the particular row can have different numbers of slots. Some may have only 1 slot, while others can have up to P slots, where P is an integer greater than 1. Accordingly, for the particular row and each possible SLT arrangement, the layout generator selects anywhere from 1 to P articles that are next in the sorted order in the remaining M-N articles. When the selected group of articles for a candidate SLT arrangement includes more than one article, the process 500 then explores summaries for each article in each slot of the SLT arrangement. Thus, within one group of articles that are selected for one SLT arrangement, the process will explore placements that do not follow the sorted order of articles. However, the order of the article summaries across row boundaries does not violate the order of the corresponding articles in the received set of articles. Thus, a summary for a first article is never placed in a second row that is after a first row that contains a summary for a second article that is later on the sorted order than the first article.

In this manner, the page layout that the process 500 produces for the page has an article summary order that is only slightly different than the order of the articles in the received sorted order. Therefore, the generated article summary layout mostly respects the original sorted order, while having an aesthetically pleasing appearance.

FIGS. 6-12 illustrate seven examples of exploring different SLT arrangements and different article summaries within individual SLT arrangements. FIG. 6 illustrates a layout generator 600 that the process 500 uses (at 515) to specify a SLT arrangement for the page 400. The process uses this layout generator to explore different solutions for each row of the layout. As shown, to explore the solution space for each row, the layout generator receives the underlying page layout design 605, the set of articles 610, and the sorted order for the received articles 615.

In several examples described above and below, the underlying page layout design is a single column layout that has multiple rows. However, one of ordinary skill will realize that the underlying page layout design has a different section structure in other embodiments. Also, the sorted order in some embodiments is an implicit order as it corresponds to the order of the articles in the received set of articles.

As shown in FIG. 6, the layout generator constructs a graph 620 to express the solution space that it is exploring. This graph has a tree structure that has multiple levels of nodes, with each level corresponding to a different row in the page layout. Each node in each level corresponds to a different article summary solution for that level's corresponding row. One node can be parent node of one or more other nodes. In the solution space graph, a parent first node that is connected to a child second node signifies a first article summary solution for a first row that is followed by a second article summary solution of a second row that is immediately after the first row.

FIG. 6 illustrates the selection of the single slot snake breaker 460 for the first row. This snake breaker contains an article about a fire in this example. In some embodiments, the layout generator 600 of the process 500 has to start a page layout with a single-slot snake breaker 460, or is heavily biased towards selecting such a snake breaker. Also, in some of these embodiments, the layout generator has to select the article to place in the first row from among a subset of articles that are assessed to be premium articles (e.g., from premium partners). In some embodiments, this article is one article that can violate the constraint against articles jumping the order across the row boundaries.

Each of the FIGS. 6-10 shows as filled-in, the node in the solution space graph that represents an article summary layout solution for that node's corresponding row. Next to each filled-in node, each figure lists an exemplary score that reflects an overall score of the layout if a node's layout solution and each of its parent solutions are used in the page. For instance, FIG. 6 shows a partially completed graph 625 with its root node as being filled in to specify that the single snake breaker 460 with the fire-related article has been selected for the first row of the page layout 400. A score of 12 is written next to the root node.

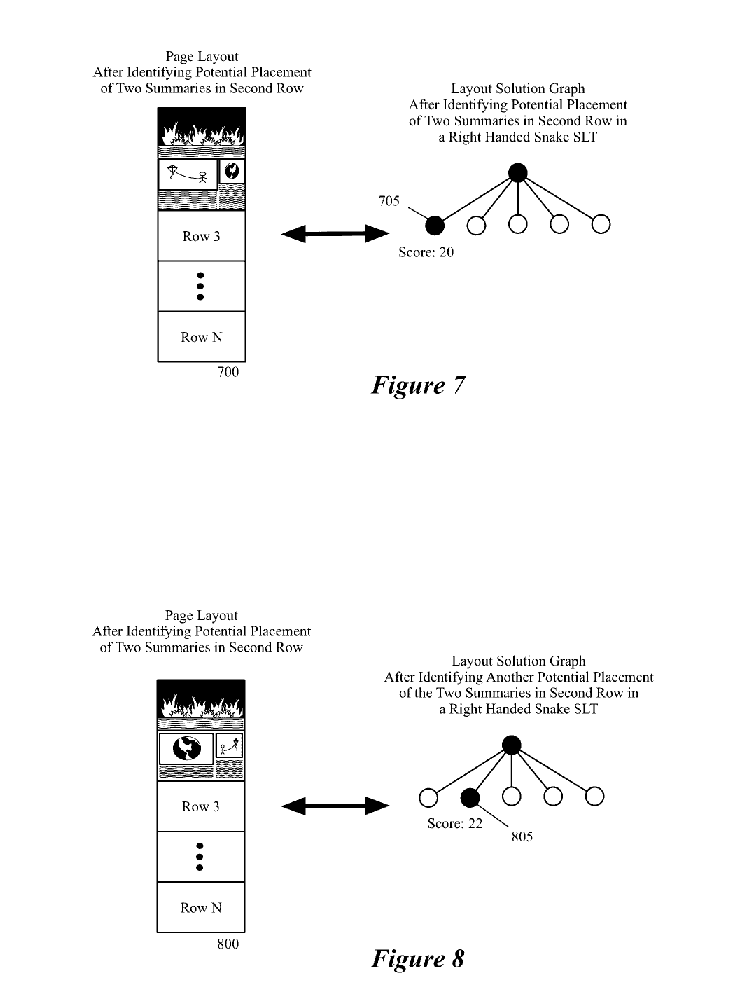

FIGS. 7 and 8 illustrate two different layout solutions 700 and 800 for the second row of the page. Both of these solutions use the same two articles in the same right-handed snake SLT. However, these two solutions switch the order of the articles in the narrow and broader portions of the vertical snake SLT. Also, in both of these examples, the vertical portion of the snake is shown to include only one article's summary. In addition, each of these solutions is shown as a different filled-in node 705 or 805 in the solution space graph. Next to each node, each figure shows the score (20 or 22) of the page layout that includes that node's layout solution for the node's row as well as the layout solution for the root node.

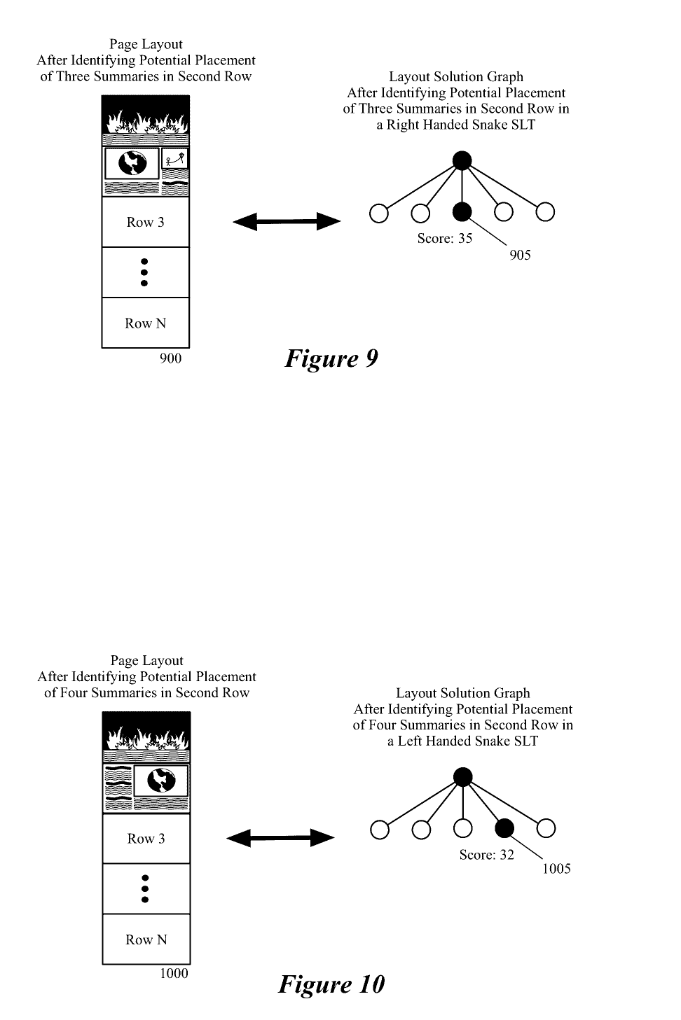

FIG. 9 illustrates another layout solution 900 for the second row of the page. This solution also uses the right-handed snake SLT, but now it places two articles in the vertical snake portion of this snake. This layout is the layout solution that the layout generator selects for the second row as shown in FIG. 4. In the second level of the node graph, FIG. 9 illustrates (1) another filled-in node 905 that represents the layout solution 900 in this graph, and (2) a score (35) for the layout up to this node's layout solution.

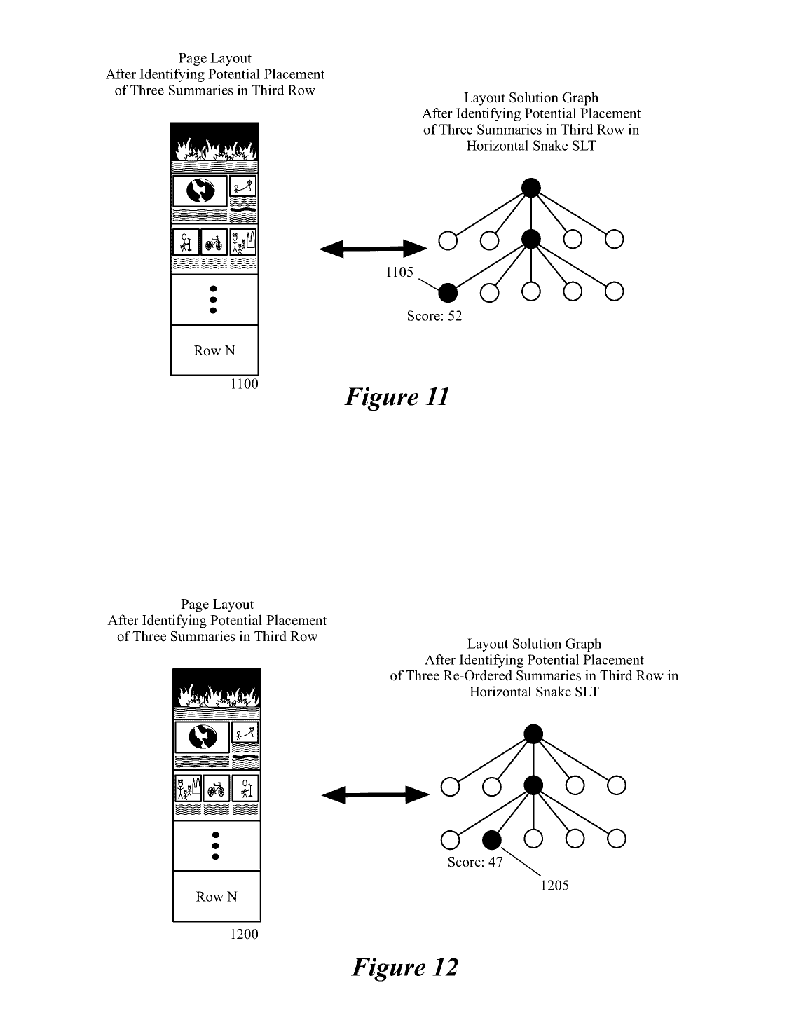

FIG. 10 illustrates yet another layout solution 1000 for the second row of the page. This solution uses the left-handed snake SLT, and places three text-only summaries in the vertical snake portion of this SLT. This solution is represented by another filled-in node 1005 in the second level of the node graph, and a score of 32 next to this node.

At 515, the process 500 selects the layout solution (i.e., the combination of an SLT and a CSP set for the SLT) that produces the best score for that row given the selected layout for the previous row(s) (i.e., for the set of sibling nodes in the solution space graph that have the same parent node). In its next iteration through 515, the process explores solutions for the next row on the page based on the solution that it picked for the current row. For the examples illustrated in FIGS. 6-10, the layout solution 900 of FIG. 9 with associated with node 905 results in the best score (35) of all the solutions explored for the second row. Hence, the process 500 selects (at 515) this second-row solution. In its exploration of solutions for the third row (i.e., in its next iteration through 515), the process then examines third-row solutions that work with this selected second-row solution (of FIG. 9) and that are scored in relationship to this second-row solution.

FIGS. 11 and 12 illustrate examples of the process 500 exploring third-row solutions that are off the second-row solution of FIG. 9. In both of these examples, the process 500 has selected a horizontal snake SLT and picked the same three articles. These two examples only differ in the order of the articles in the slots of the horizontal SLT for their respective layout solutions 1100 and 1200. These two solutions are identified as two different nodes 1105 and 1205 in the third level of the solution space graph, and the scores (52 and 47) for each of these solutions is shown next to its node. In some embodiments, the process 500 does not flip the order of the same set of articles in a horizontal snake SLT because the scoring function that it uses does not result in different scores for these different solutions.

When the process 500 determines (at 520) that it has identified a page layout that places summaries for all of the articles that it received at 505, the process transitions to 530, where it determines whether it has completely explored the solution space. If so, the process transitions to 550, which will be described below. If the process determines that it has not fully explored the solution space, the process determines (at 535) whether it has additional time to explore other solutions. In some embodiments, the reader and its associated process 500 execute on a mobile device. In some of these embodiments, the process bases its determination at 535 on whether it has additional time before it needs to display the article feed page to a user.

When the process determines (at 535) that it has additional time to explore more solutions, the process identifies (at 540) the best partial solution that it previously identified but has not fully explored to find a placement for all of the articles in the layout. To identify this partial solution, the process identifies (at 540), in the solution space graph, the non-leaf node that does not have any child nodes and that has the highest score in comparison to other non-leaf nodes that do not have any child nodes. Next, at 545, the process selects the row that follows the non-leaf node row selected at 540, and then transitions to 515 to explore article summary layout solutions for this newly selected row based on the layout solution of the selected non-leaf node.

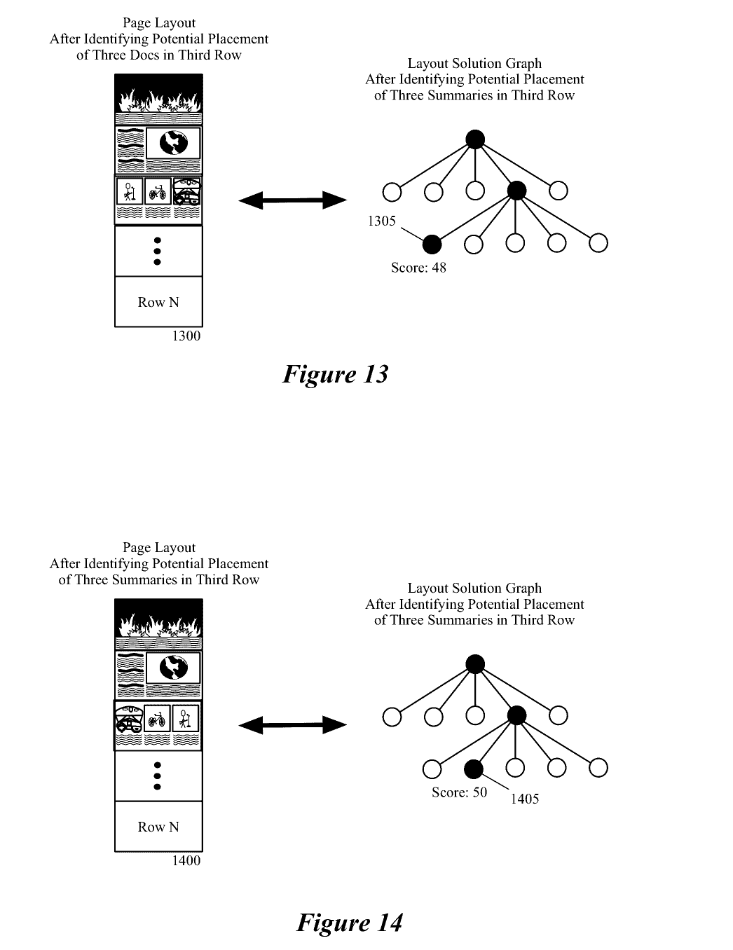

FIGS. 13 and 14 illustrate examples of the process 500 exploring third-row solutions that are off the second-row solution of FIG. 10, which after the solution 900 of FIG. 9 resulted in the next best second-row solution score (32). More specifically, after identifying a complete layout solution that places all the articles in the page layout, the process 500 selects non-leaf node 1005 because it has not yet explored a complete solution for this node and this node has the best score in the group of non-leaf nodes that do not have any child nodes.

In both of these examples, the process 500 has selected a horizontal snake SLT and picked the same three articles. These two layout examples 1300 and 1400 only differ in the order of the articles in the slots of the horizontal SLT. These two solutions are identified as two different nodes 1305 and 1405 in the third level of the solution space graph, and the scores for each of these solutions is shown next to its node.

Once the process determines (at 535) that it does not have additional time to explore more solutions, it transitions to 550. In the middle of exploring a solution (e.g., while the process is looping through 515-525), the process in some embodiments can also exit the solution space exploration when it has already identified a complete solution and it determines that it needs to present an article feed layout page. In this situation, the process also transitions to 550.

At 550, the process 500 selects the feed summary page layout for the set of articles received at 505. When the process has identified only one complete solution for all the articles by the time it reaches 550, the process simply picks that complete solution. On the other hand, when the process 500 has identified more than one complete solution by the time it reaches 550, the process selects (at 550) the complete solution that has the highest score. In some embodiments, the score of a complete solution is the score of the last selected child node of the solution, because each particular node's score in these embodiments accounts for the scores of each of the parent nodes (i.e., parent node, grandparent node, great grandparent node, etc.) of that particular node.

After 550, the process 500 ends.

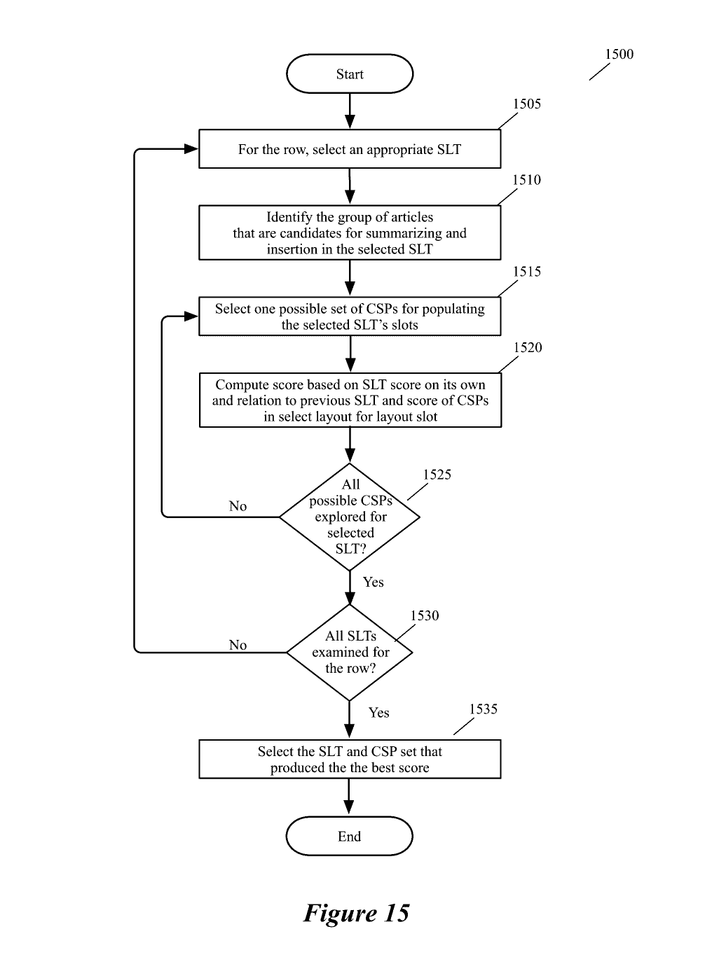

FIG. 15 illustrates a process 1500 that the process 500 performs (at 515) to explore for one row, one or more SLTs and one or more CSPs for each explored SLT. The process 1500 starts (at 1505) by selecting an appropriate SLT for the row. In some embodiments, an SLT has to be appropriate for the number of articles that remain to be summarized and placed in the feed summary page layout. For instance, when only two articles remain, the process 1500 should not select an SLT that has three or more slots for article summaries.

Also, in some embodiments, an SLT for a row has to be appropriate in view of the SLT that was selected for the previous row. For instance, as described above by reference to FIG. 2, an asymmetric snake breaker 135 or 140 cannot follow horizontal snake arrangement 120 in some embodiments. Also, once a snake pattern starts, the process 1500 has to alternatively select vertical and horizontal snake arrangements until it had selected a minimum number of these arrangements in some embodiments, as described above. In some embodiments, these design objectives are enforced by constraints that prevent the process 1500 from selecting an SLT for a row that does not match an SLT for the previous row. Alternatively or conjunctively, these design objectives can be achieved by penalizing undesirable choices.

After selecting the SLT, the process 1500 identifies (at 1510) a group of articles that are candidates for summarizing and placing in the selected SLT. In some embodiments, the process 1500 selects (at 1510) the articles according to the received sorted order. While most SLTs have a fixed number of slots for a fixed number of article summaries, a variable number (e.g., from 2 to 4) can be placed in the vertical snake SLTs. For such vertical snake SLTs, the process 1500 examines several different groups of articles, but each group of articles only includes one sub-set of contiguous articles in the received set of articles.

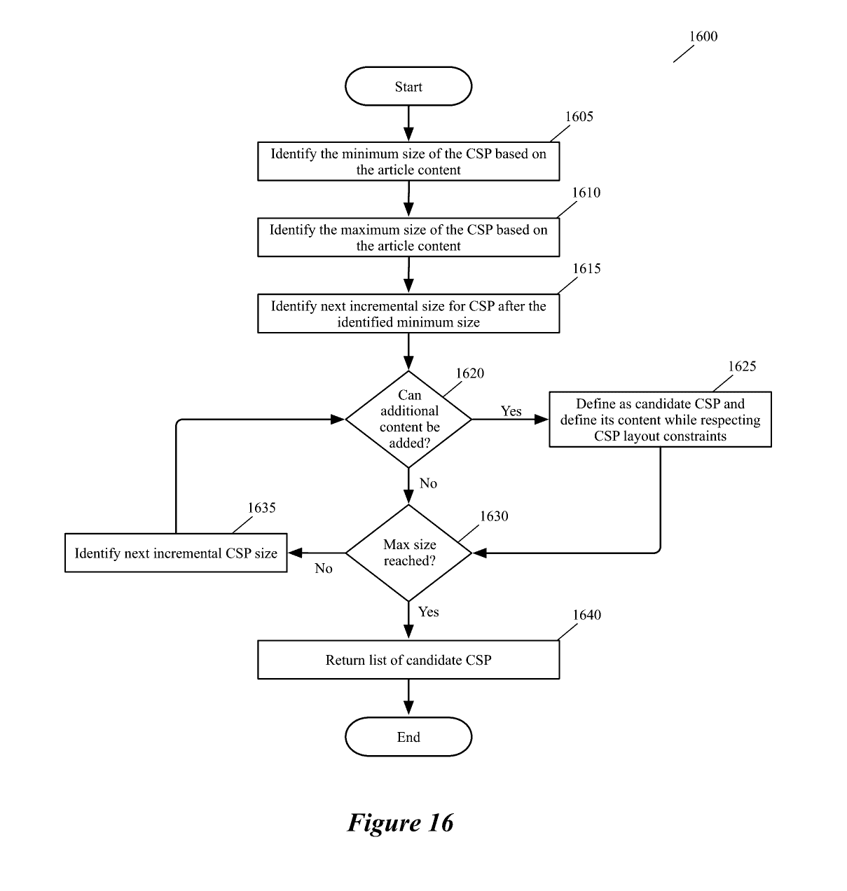

After 1510, the process 1500 selects (at 1515) one possible set of CSPs for populating the selected SLT's slots. In some embodiments, exploring different CSPs for an SLT entails placing different article summaries in different slots of an SLT, varying the sizes of the SLT slots, and/or including different amounts of content for each article in each SLT slot. This exploration is further explained below by reference to FIG. 16.

Next, at 1520, the process computes a score for the identified set of CSPs and the selected SLT. In some embodiments, the score (at 1520) is identified based on (1) a score for the SLT that the section arrangement uses, (2) a score for placing the identified SLT for this row next to the SLT selected for the previous row, and (3) a score for the set of identified CSPs that are to be placed in the article summary slot(s) of the SLT identified for the current row. In some embodiments, this scoring is defined in order to produce an aesthetically pleasing layout of article summaries on the page.

For instance, the generated score for a CSP accounts for the image size, image aspect ratio, overall aspect ratio, percentage of text-to-image and amount of whitespace. The individual score for each of these factors is then combined by weight values that are defined to achieve a certain balance between the whitespace, image size, image aspect ratio, overall aspect ratio and text-to-image percentage in the article summary (i.e., in the CSP). In some embodiments, the process 1500 uses a linked-list of scoring functions to generate the score for each CSP. Each scoring function in the list computes the score along one scoring dimension (such as the whitespace score, image size score, image aspect ratio score, etc.). Each scoring function also (1) calls the next scoring function on the list, and (2) returns to the function that called it a weighted sum of the score that it computed along with the score that was returned by the function that it called, if any. In this manner, scoring functions can be easily added or removed in order to modify how the CSP scoring is performed in some embodiments.

After 1520, the process determines (at 1525) whether it has examined all possible CSPs for the SLT selected at 1505. If not, the process returns to 1515 to identify another possible set of CSPs for the selected SLT slot(s). When the process has examined all possible CSPs for the selected SLT, the process determines (at 1530) whether it has examined all appropriate SLTs for the row. If not, it returns to 1505 to select another appropriate SLT for the row. Otherwise, the process selects (at 1535) the SLT and CSP set that produced the best score in the various iterations through 1520, as the SLT and CSP set for the row. After 1535, the process ends.

FIG. 16 illustrates a process 1600 that generates all possible CSPs for an article and an SLT. In some embodiments, the process 1500 performs (at 1515) the process 1600 to identify all CSPs that it needs to examine for a selected SLT and an article. The different examined CSPs include different sized CSPs. By varying the sizes of the CSPs, the layout generator of some embodiments varies the size of the SLTs and the page layout rows that it uses.

As shown, the process 1600 initially identifies (at 1605) the minimum size for a CSP that contains an acceptable article summary (i.e., as an acceptable candidate CSP). This smallest CSP in some embodiments is a CSP that can contain the title for the article along with metadata (e.g., source, age, etc.) about the article.

Next, at 1610, the process identifies the maximum size of a CSP for the article. For this maximum size, the process defines (at 1610) one or more candidate CSPs, with each candidate CSP having a different article summary content. In some embodiments, the process defines (at 1610) only one CSP at the maximum CSP size. The process 1600 identifies the maximum CSP size based on different factors in different embodiments. One factor is the size and aspect ratio of the slot(s) of the selected SLT. Another factor is based on the type of article content that can be included in the CSP and the maximum amount of this content. In some embodiments, the process 1600 generates the article summary content from three different types of content that are contained in the rich site summary (RSS) feed for the article. The three types of content are a title, an image, and an excerpt for the article. The excerpt of some embodiments is a portion (or brief summary) of the full written content of the article.

In some embodiments, the maximum amount of this content that can be included in the largest CSP includes (1) the image at the maximum desired aspect ratio that is dependent on the sub-column span of the SLT slot, (2) the full article title, and (3) up to Y lines (e.g., 10 lines) of excerpt from the article.

After identifying minimum and maximum CSP sizes, the process identifies (at 1615) another CSP size that is incrementally larger than the minimum CSP size. In some embodiments, the process increments (at 1615) the height of the CSP by Y pixels (e.g., four pixels). Next, at 1620, the process determines whether it can add additional content to the article summary that is provided in a CSP with the identified incrementally larger size. In some embodiments, the process discards the incrementally larger CSP size when it determines (at 1620) that it cannot accommodate one additional line of excerpt or another increase in the size of the image. Also, to fit an image in a CSP, the process uses a variety of cropping techniques to crop the image. These techniques are further described in concurrently filed U.S. patent application entitled “Article Authoring, Distribution and Rendering Architecture”, with the attorney docket number “APLE.P0672”.

When the process 1600 determines (at 1620) that no additional content can be added for the identified incrementally larger CSP size, the process transitions to 1630, which will be described below. Otherwise, when the incrementally increased CSP size can accommodate additional article content, the process defines (at 1625) one or more candidate CSPs for this size. When more than two candidate CSPs are defined for this size, the CSPs differ in the type of content that they include. In some embodiments, the process only defines (at 1625) one CSP for each identified CSP size. Also, in some embodiments, the process defines the content of a CSP in a manner that satisfies one or more constraints, as described above and further described below. From 1625, the process transitions to 1630.

At 1630, the process determines whether the next incremental CSP size is the maximum CSP size, which the process previously processed at 1610. If not, the process identifies (at 1635) the next CSP size and returns to 1620 to determine whether it can add additional article content to an article summary that is to be provided in a CSP of this size. In some embodiments, the process increments the height of the CSP by Y pixels (e.g., four pixels) in each of its iterations through 1635. When the process determines (at 1630) that the next CSP size is the maximum CSP size, the process returns (at 1640) a list of candidate CSPs to the process 1500, and then ends.

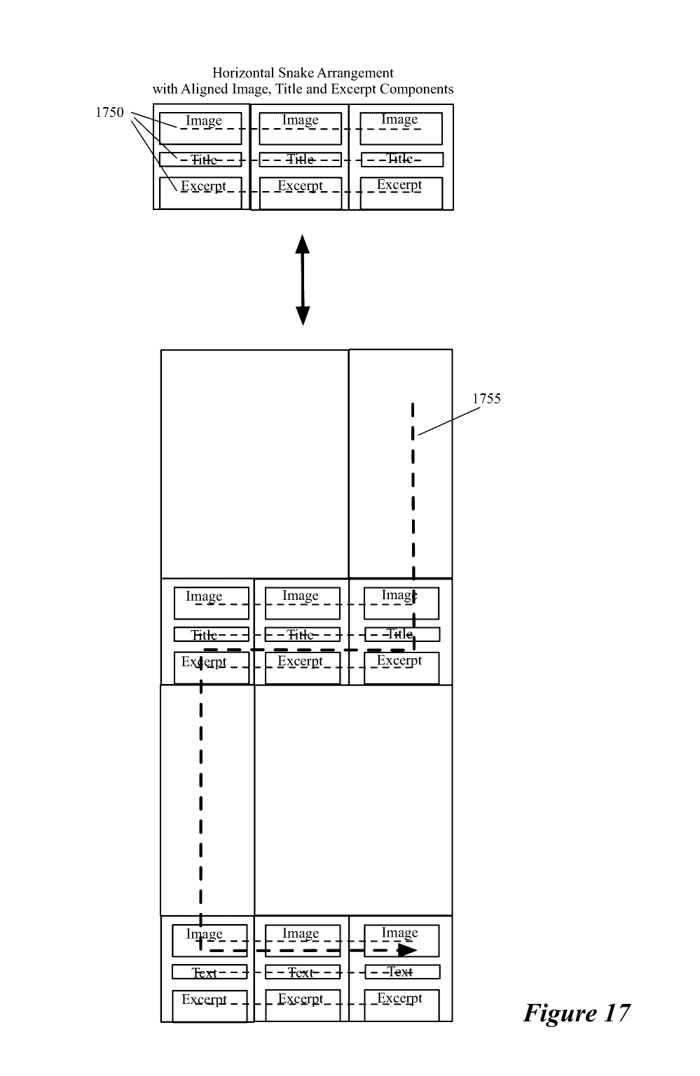

In some embodiments, the process 1500 does not explore all possible combinations of CSPs that it gets for two or more articles that have to be summarized in an SLT. For instance, the CSPs for the different article summaries have to satisfy a set of constraints before they are placed next to each other. FIG. 17 illustrates an example of one such constraint. In this example, the CSPs that are used to populate the slots of horizontal snake SLTs have their image, title and excerpt sections aligned along the horizontal axis, as indicated by the thinner dashed lines 1750 that is shown to pass through these CSP components. The alignment of these sub-components further accentuates the visual appearance of the layout as it makes the presentation of the CSPs in horizontal snake components symmetric along the horizontal directions that a snake pattern 1755 travels along these components. To produce the symmetric layout of the CSPs, the process 1500 in some embodiments does not explore combinations of CSPs that have asymmetric sub-component layouts with respect to each other. In other words, the process 1500 only explores, in some embodiments, CSP combinations for a horizontal snake component where the CSPs have their sub-component layouts (i.e., layouts of images, titles or excerpts) aligned with each other.

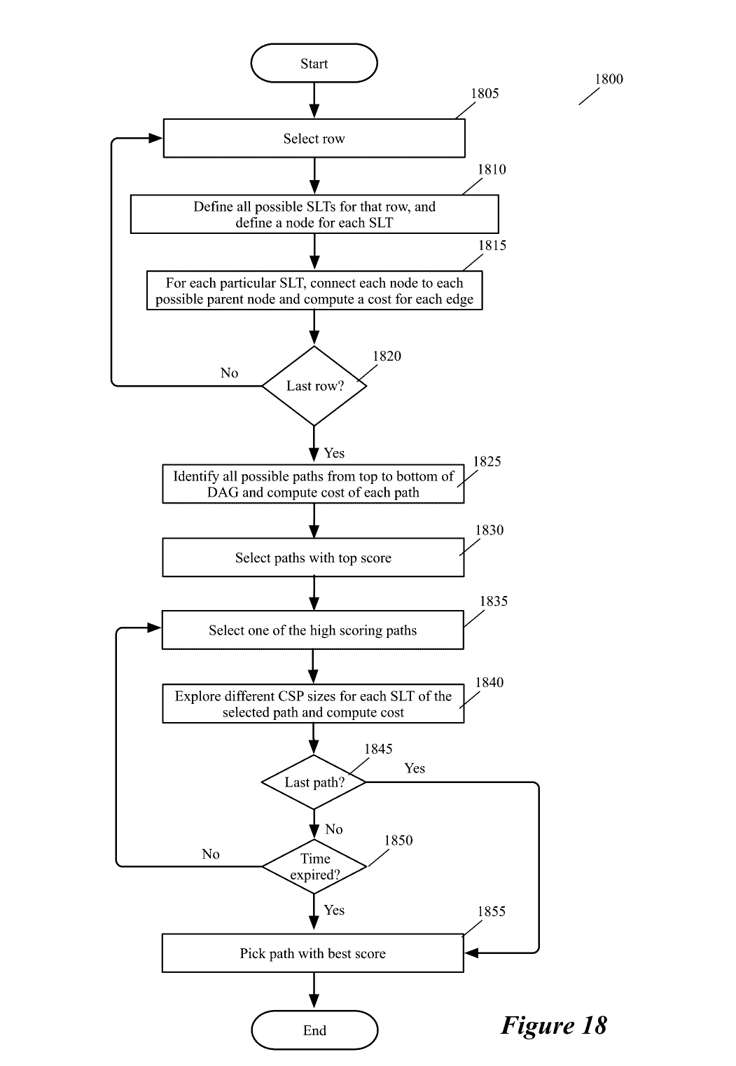

One of ordinary skill will realize that the layout generator in other embodiments explores the solution space in different manners than the approach described above by reference to FIG. 5. FIG. 18 illustrates a process 1800 that the layout generators of some embodiments use to explore the solution space. Like the process 500 of FIG. 5, the process 1800 of FIG. 18 explores the solution space in a manner that produces aesthetically pleasing page layout arrangements while respecting the received sorted order of the documents.

The process 1800 uses a multi-pass approach to define the layout of document summaries across a set of rows of a page. In some of these embodiments, the page layout is one column of vertically aligned rows, and the page sections are the rows. In the multi-pass approach, the process 1800 defines a directed acyclic graph (DAG) in which multiple nodes are defined at multiple levels of the DAG and each node can have multiple parent nodes and multiple child nodes, but no node can be a parent of a higher level node. For each row, the process, in a first pass (specified as operations 1805-1820), defines all candidate SLT arrangements for that row and defines a node in the DAG for each defined SLT arrangement, while in a second pass (specified as operations 1825-1855), the process explores different CSPs for the SLTs that are identified by each of several of the best paths in order to identify the path that has the best layout score.

As shown, the first pass of the process 1800 starts by the process selecting (at 1805) a row. In some embodiments, the process receives N documents to summarize in a feed layout of R rows. In some embodiments, the process 1800 can only explore feed layouts with a fixed number of R rows, while in other embodiments, the process 1800 can explore feed layouts with a different number of rows. Also, in some embodiments, the layout generator performs the process 1800 iteratively with each iteration defining the layout of the summaries of the next N documents.

Next, at 1810, the process 1800 defines all candidate SLT arrangements for the selected row and defines a node in the DAG for each defined SLT arrangement. The process defines the nodes for one selected row (i.e., in each iteration of 1810) at the same level of the DAG that represents the SLT solutions for that row of the layout. At 1810, the process in some embodiments defines nodes for SLT arrangements that are feasible (i.e., can serve as candidate SLT arrangements) for the selected row.

In the first pass, the process 1800 identifies (at 1815) each possible transition between the SLT arrangements of one row and the SLT arrangements of the next subsequent row. As mentioned above, some transitions are not possible, as not every SLT can follow every other SLT in some embodiments. For each possible transition between two SLTs of two adjacent rows, the process 1800 specifies (at 1815) an edge between the two nodes that represent the two SLTs in the DAG, and assigns (at 1815) a score to the edge to express the desirability of the transition from the first SLT to the second SLT.

For the nodes associated with the first row, the process 1800 in some embodiments associates these nodes with a default root node that represents either the top of the page or the node of the last SLT that the process 1800 selected for the last set of articles that this process processed. In some embodiments, the edge transition score from a default root node that represents the top of the page corresponds to the desirability of the SLT of the selected row's node as the first SLT of the page. On the other hand, the edge transition score from a default root node that represents the last SLT of the previous set of placed document summaries, corresponds to the desirability of the SLT of the selected row's node as the SLT that is to follow the last SLT from the previously processed set of document summaries.

At 1820, the process 1800 determines whether it has specified candidate SLTs and generated nodes in the DAG for all the rows. If not, the process returns to 1805 to select the next row on the page layout. Otherwise, the process transitions to 1825. When the process transitions to 1825, it has completed the first pass by defining the candidate SLTs for the set of rows, defining the DAG nodes for these SLTs, and scoring the transitions between the DAG nodes to quantify the transitions between candidate SLTs of different nodes.

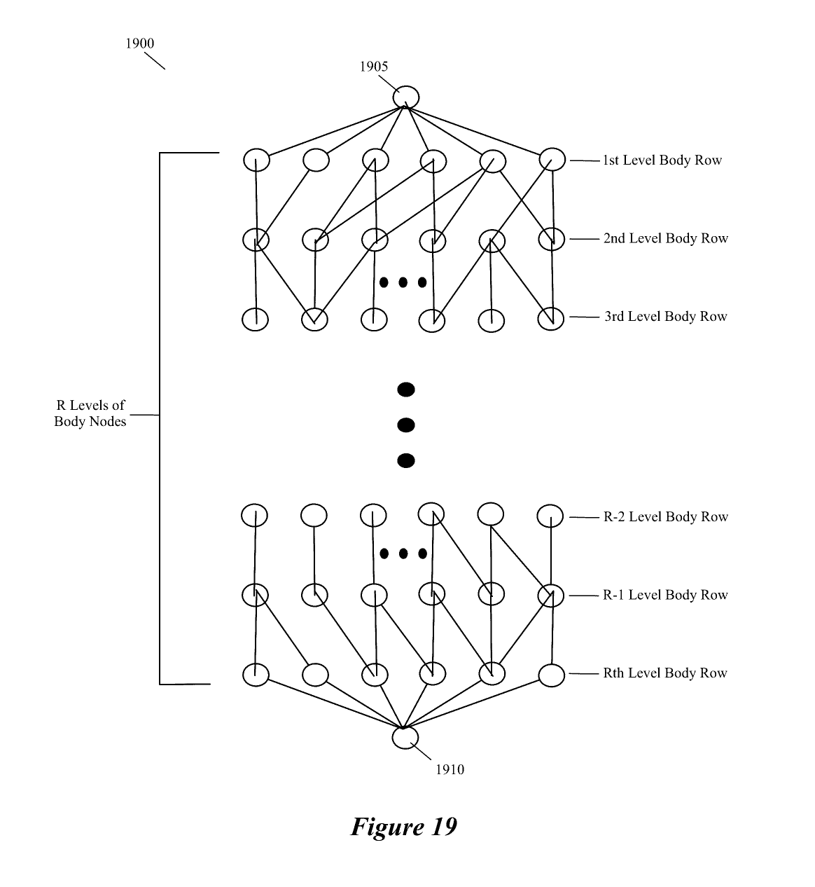

FIG. 19 illustrates an example of one DAG structure 1900 that is created by the first pass. This structure has (1) R node levels that correspond to R rows of the page, (2) a default root node 1905 that corresponds to the top of the page or the last row of the last processed set of documents, and (3) a default end node 1910 that defines the end of the rows being currently processed. The R levels of nodes are referred to as body or interior level nodes, as they are neither the root level node 1905 nor the end node 1910. The nodes on each body level of the DAG represent the candidate SLT arrangements for the row represented by that level. According to this approach, the candidate SLT arrangements of one row are all on the same level in the DAG. The number of nodes in different levels of the DAG can be different, as different numbers of SLTs can be available candidate SLTs for different rows of the page.

As mentioned above, the default root node 1905 in some embodiments represents either the top of the page or the node of the last SLT that the process 1800 selected for the last set of articles that this process processed. In some embodiments, the end node 1910 is a DAG processing construct that is meant to facilitate quantifying the desirability of an SLT in the last body level as being a desirable end SLT arrangement for the set of N documents. In some embodiments, the end node 1910 helps quantify the desirability by virtue of the transition score of the edge from the node of a last-body level SLT to the end node. In other embodiments, the end node does not serve this purpose, but rather simply terminates the DAG. In addition to computing a score for the edges to the end node 1910, the process 1800 computes a score for each of the edges shown in FIG. 19, and each edge's score quantifies the desirability of the transition between the two SLTs that are represented by the two nodes connected by the edge.

At 1825, the process 1800 starts the second pass. At 1825, the process identifies all complete paths from the top to the bottom of the DAG, and computes the score of each path by summing the scores of the DAG edges (i.e., the transitions between the nodes) taken by the path. Each path is formed by (1) a unique contiguous set of DAG edges that connects the top of the DAG (e.g., the top default node of the DAG) to the bottom of the DAG (e.g., the bottom end node of the DAG), and (2) the DAG nodes connected by these DAG edges. Each path represents one complete SLT layout solution for the document summaries that are to be placed in the set rows. Each path's SLT layout solution includes the SLT arrangement of each node of the path. Each path's score represents the desirability of the transitions between the SLT arrangements of the path (i.e., the SLT arrangements that are represented by the nodes on the path).

Next, at 1830, the process 1800 identifies a set of paths that have the highest score. In some cases, this set includes only one path, while in other cases, this set includes multiple paths. The layout generator iteratively examines each path in the identified set to explore different document summary placements, contents and sizes in the SLT/CSP arrangements of the path. Specifically, at 1835, the process selects one of the paths identified at 1830. Next, at 1840, the process explores different document summary placements, contents and sizes in the SLT arrangements of each node in this selected path. In some embodiments, the process 1800 limits its exploration of the solution space in the same manner as described above by reference to the previous figures. This limitation is meant to restrict the process 1800's exploration of different document summaries for different rows to a constrained boundary about the received order of the documents. This constraint would allow the document summary order to be modified in a group of documents selected for a particular row, but would not allow the document summary order across the rows to violate the received document order. For each node in the selected path, the process selects (at 1840) the SLT and CSP solution that produces the best score.

After identifying the SLT/CSP arrangements for each node of the selected path, the process 1800 determines (at 1845) whether it has analyzed all of the paths identified at 1830. If so, it transitions to 1855, which will be described below. Otherwise, when the process determines (at 1845) that it still has other paths to examine, the process determines (at 1850) whether it has time to explore other high scoring paths that were identified at 1830. To limit the exploration of the layout generator, some embodiments use a static or dynamic timer (e.g., fixed timer or a timer based on user actions) to restrict the time that the layout generator has to explore the high-scoring paths in the identified set in the second pass.

When the process determines (at 1850) that the time has not expired, it returns to 1835 to select another high-scoring path. Otherwise, the process transitions to 1855, where it selects the SLT layout arrangement of the path that produced the best cumulative score across all of its SLT arrangements. In some embodiments, the best cumulative score does not account for the edge transition score, but only accounts for the SLT/CSP scores computed (at 1840) in the second pass. In these embodiments, the edge costs (identified in the first pass) are used at the start of the second pass to identify one or more of the “best” paths with the best SLT transition arrangements, while the SLT/CSP costs (computed at 1840) for the SLT arrangements of each path determine which of the “best” paths produces the best SLT/CSP arrangement. In other embodiments, the best cumulative score (used at 1855) account for both the edge transition score and the SLT/CSP scores. The SLT layout arrangement that is selected (at 1855) specifies the SLTs for the set of rows, and the CSPs in these SLTS.

In some embodiments, the process 1800 may determine (at 1840) that a node on a high scoring path is an SLT arrangement that is not feasible for the documents that need to be summarized in the SLT. In such a case, the process 1800 filters out (at 1840) that node and all paths that use that node. This filtering might eliminate (at 1840) some or all of the high-scoring paths (identified at 1830) because multiple paths might use the same node. When all the high-scoring paths are filtered out, the layout generator would have to return to 1830 (from 1840) to select another set of high-scoring paths by identifying the next highest path score and identifying the paths that have this next highest path score.

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

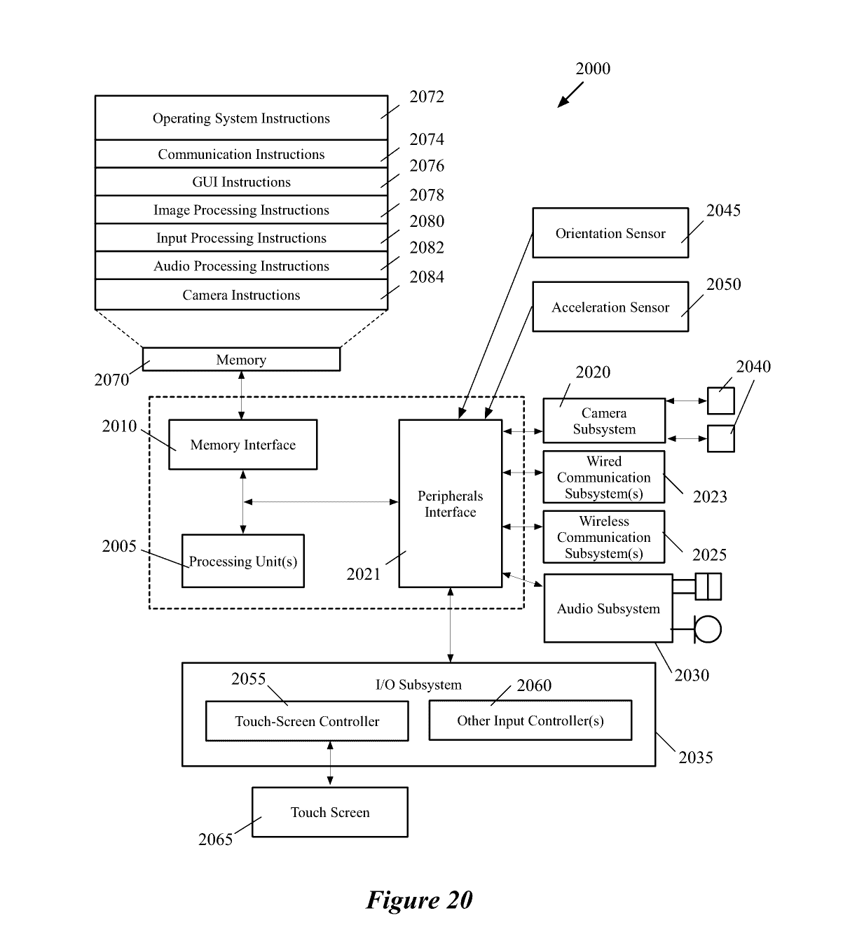

The applications of some embodiments operate on mobile devices, such as smart phones (e.g., iPhones®) and tablets (e.g., iPads®). FIG. 20 is an example of an architecture 2000 of such a mobile computing device. Examples of mobile computing devices include smartphones, tablets, laptops, etc. As shown, the mobile computing device 2000 includes one or more processing units 2005, a memory interface 2010 and a peripherals interface 2015.

The peripherals interface 2015 is coupled to various sensors and subsystems, including a camera subsystem 2020, a wireless communication subsystem(s) 2025, an audio subsystem 2030, an I/O subsystem 2035, etc. The peripherals interface 2015 enables communication between the processing units 2005 and various peripherals. For example, an orientation sensor 2045 (e.g., a gyroscope) and an acceleration sensor 2050 (e.g., an accelerometer) is coupled to the peripherals interface 2015 to facilitate orientation and acceleration functions.

The camera subsystem 2020 is coupled to one or more optical sensors 2040 (e.g., a charged coupled device (CCD) optical sensor, a complementary metal-oxide-semiconductor (CMOS) optical sensor, etc.). The camera subsystem 2020 coupled with the optical sensors 2040 facilitates camera functions, such as image and/or video data capturing. The wireless communication subsystem 2025 serves to facilitate communication functions. In some embodiments, the wireless communication subsystem 2025 includes radio frequency receivers and transmitters, and optical receivers and transmitters (not shown in FIG. 20). These receivers and transmitters of some embodiments are implemented to operate over one or more communication networks such as a GSM network, a Wi-Fi network, a Bluetooth network, etc. The audio subsystem 2030 is coupled to a speaker to output audio (e.g., to output voice navigation instructions). Additionally, the audio subsystem 2030 is coupled to a microphone to facilitate voice-enabled functions, such as voice recognition (e.g., for searching), digital recording, etc.

The I/O subsystem 2035 involves the transfer between input/output peripheral devices, such as a display, a touch screen, etc., and the data bus of the processing units 2005 through the peripherals interface 2015. The I/O subsystem 2035 includes a touch-screen controller 2055 and other input controllers 2060 to facilitate the transfer between input/output peripheral devices and the data bus of the processing units 2005. As shown, the touch-screen controller 2055 is coupled to a touch screen 2065. The touch-screen controller 2055 detects contact and movement on the touch screen 2065 using any of multiple touch sensitivity technologies. The other input controllers 2060 are coupled to other input/control devices, such as one or more buttons. Some embodiments include a near-touch sensitive screen and a corresponding controller that can detect near-touch interactions instead of or in addition to touch interactions.

The memory interface 2010 is coupled to memory 2070. In some embodiments, the memory 2070 includes volatile memory (e.g., high-speed random access memory), non-volatile memory (e.g., flash memory), a combination of volatile and non-volatile memory, and/or any other type of memory. As illustrated in FIG. 20, the memory 2070 stores an operating system (OS) 2072. The OS 2072 includes instructions for handling basic system services and for performing hardware dependent tasks.

The memory 2070 also includes communication instructions 2074 to facilitate communicating with one or more additional devices; graphical user interface instructions 2076 to facilitate graphic user interface processing; image processing instructions 2078 to facilitate image-related processing and functions; input processing instructions 2080 to facilitate input-related (e.g., touch input) processes and functions; audio processing instructions 2082 to facilitate audio-related processes and functions; and camera instructions 2084 to facilitate camera-related processes and functions. The instructions described above are merely exemplary and the memory 2070 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 20 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 20 may be split into two or more integrated circuits.

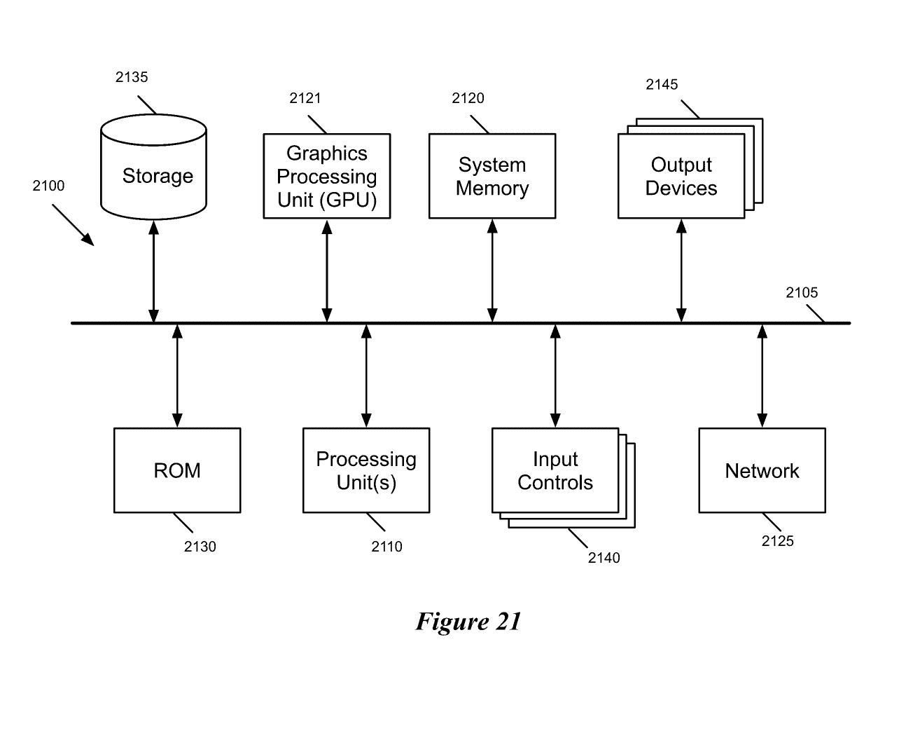

FIG. 21 conceptually illustrates another example of an electronic system 2100 with which some embodiments of the invention are implemented. The electronic system 2100 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2100 includes a bus 2105, processing unit(s) 2110, a graphics processing unit (GPU) 2115, a system memory 2120, a network 2125, a read-only memory 2130, a permanent storage device 2135, input devices 2140, and output devices 2145.

The bus 2105 collectively represents all system, peripheral, and chipset buses that communicatively connect the numerous internal devices of the electronic system 2100. For instance, the bus 2105 communicatively connects the processing unit(s) 2110 with the read-only memory 2130, the GPU 2115, the system memory 2120, and the permanent storage device 2135.

From these various memory units, the processing unit(s) 2110 retrieves instructions to execute and data to process in order to execute the processes of the invention. The processing unit(s) may be a single processor or a multi-core processor in different embodiments. Some instructions are passed to and executed by the GPU 2115. The GPU 2115 can offload various computations or complement the image processing provided by the processing unit(s) 2110.

The read-only-memory (ROM) 2130 stores static data and instructions that are needed by the processing unit(s) 2110 and other modules of the electronic system. The permanent storage device 2135, on the other hand, is a read-and-write memory device. This device is a non-volatile memory unit that stores instructions and data even when the electronic system 2100 is off. Some embodiments of the invention use a mass-storage device (such as a magnetic or optical disk and its corresponding disk drive, integrated flash memory) as the permanent storage device 2135.

Other embodiments use a removable storage device (such as a floppy disk, flash memory device, etc., and its corresponding drive) as the permanent storage device. Like the permanent storage device 2135, the system memory 2120 is a read-and-write memory device. However, unlike storage device 2135, the system memory 2120 is a volatile read-and-write memory, such a random access memory. The system memory 2120 stores some of the instructions and data that the processor needs at runtime. In some embodiments, the invention's processes are stored in the system memory 2120, the permanent storage device 2135, and/or the read-only memory 2130. For example, the various memory units include instructions for processing multimedia clips in accordance with some embodiments. From these various memory units, the processing unit(s) 2110 retrieves instructions to execute and data to process in order to execute the processes of some embodiments.

The bus 2105 also connects to the input and output devices 2140 and 2145. The input devices 2140 enable the user to communicate information and select commands to the electronic system. The input devices 2140 include alphanumeric keyboards and pointing devices (also called “cursor control devices”), cameras (e.g., webcams), microphones or similar devices for receiving voice commands, etc. The output devices 2145 display images generated by the electronic system or otherwise output data. The output devices 2145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 21, bus 2105 also couples electronic system 2100 to a network 2125 through a network adapter (not shown). In this manner, the computer can be a part of a network of computers (such as a local area network (“LAN”), a wide area network (“WAN”), or an Intranet), or a network of networks, such as the Internet. Any or all components of electronic system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

We claim:

1. A method of generating a display of document summaries, the method comprising:
receiving a plurality of documents;
generating document summaries for the documents; and
arranging the document summaries on a scrollable page so that a first subset of the document summaries produces a snake pattern across the page and a second subset of the document summaries are outside of the snake pattern, the snake pattern comprising a plurality of successive vertical and horizontal snake portions.

2. The method of claim 1, wherein the first subset of document summaries that produces the snake pattern are contained wholly within the vertical and horizontal snake portions, while the second subset of document summaries are wholly outside of the vertical and horizontal snake portions.

3. The method of claim 1, wherein the snake pattern traverses down the page in the direction of the page's scrolling.

4. The method of claim 1, wherein the widths of the vertical snake portions and the heights of the horizontal snake portions have to be within a certain threshold range.

5. The method of claim 1, wherein the height of no horizontal snake portion can be larger than a certain threshold amount than the width of any vertical snake portion.

6. The method of claim 1, wherein a set of horizontal snake portions each have multiple sections for displaying multiple document summaries, wherein at least two of the sections of each horizontal snake portion in the set of horizontal snake portions (i) are on opposing ends of the horizontal snake portion, (ii) have the same width as vertical snake portions in a set of vertical snake portions, and (iii) abut vertical snake portions in the set of vertical snake portions either above or below them.

7. The method of claim 6, wherein different vertical snake portions contain different numbers of documents summaries.

8. The method of claim 1,
wherein the widths of the vertical snake portions and the heights of the horizontal snake portions have to be within a certain threshold range,
wherein the widths and heights of the second subset of document summaries is larger than the vertical-snake portion widths and horizontal-snake portion heights by another threshold amount so that the second subset of document summaries can further accentuate the appearance of the snake pattern.

9. The method of claim 1, wherein the snake pattern includes a plurality of snake segments, each snake segment includes a plurality of alternating vertical and horizontal snake portions, and different snake segments are separated by at least one document summary in the second subset of document summaries.

10. The method of claim 1, wherein
generating the document summaries comprises generating different document summaries for at least one particular document; and
arranging the document summaries comprises exploring different layout arrangements for the different document summaries that are generated for the particular document.

11. A non-transitory machine readable medium storing a program for generating a display of document summaries, the program comprising sets of instructions for:
receiving a plurality of documents;
generating document summaries for the documents; and
arranging the document summaries on a scrollable page so that a first subset of the document summaries produces a snake pattern across the page and a second subset of the document summaries are outside of the snake pattern, the snake pattern comprising a plurality of successive vertical and horizontal snake portions.

12. The non-transitory machine readable medium of claim 11, wherein the first subset of document summaries that produces the snake pattern are contained wholly within the vertical and horizontal snake portions, while the second subset of document summaries are wholly outside of the vertical and horizontal snake portions.

13. The non-transitory machine readable medium of claim 11, wherein the snake pattern traverses along a scrolling direction on the page.

14. The non-transitory machine readable medium of claim 11, wherein the widths of the vertical snake portions and the heights of the horizontal snake portions have to be within a certain threshold range.

15. The non-transitory machine readable medium of claim 11, wherein the height of no horizontal snake portion can be larger than a certain threshold amount than the width of any vertical snake portion.

16. The non-transitory machine readable medium of claim 11, wherein a set of horizontal snake portions each have multiple sections for displaying multiple document summaries, wherein at least two of the sections of each horizontal snake portion in the set of horizontal snake portions (i) are on opposing ends of the horizontal snake portion, (ii) have the same width as vertical snake portions in a set of vertical snake portions, and (iii) abut vertical snake portions in the set of vertical snake portions either above or below them.

17. The non-transitory machine readable medium of claim 16, wherein different vertical snake portions contain different numbers of documents summaries.

18. The non-transitory machine readable medium of claim 11,
wherein the widths of the vertical snake portions and the heights of the horizontal snake portions have to be within a certain threshold range,
wherein the widths and heights of the second subset of document summaries is larger than the vertical-snake portion widths and horizontal-snake portion heights by another threshold amount so that the second subset of document summaries can further accentuate the appearance of the snake pattern.

19. The non-transitory machine readable medium of claim 11, wherein the snake pattern includes a plurality of snake segments, each snake segment includes a plurality of alternating vertical and horizontal snake portions, and different snake segments are separated by at least one document summary in the second subset of document summaries.

20. The non-transitory machine readable medium of claim 11, wherein
the set of instructions for generating the document summaries comprises a set of instructions for generating different document summaries for at least one particular document; and
the set of instructions for arranging the document summaries comprises a set of instructions for exploring different layout arrangements for the different document summaries that are generated for the particular document.
